(19) United States
(12) Patent Application Publication
(10) Pub. No.: US 2024/0252964 A1
(43) Pub. Date: Aug. 1, 2024

(54) FILTER MEDIA WITH BIODEGRADABLE FIBERS

(71) Applicant: University of Tennessee Research Foundation

(72) Inventors: Uday Kumar Vasant Vaidya, Birmingham, AL (US); Ganesh Deka, Duluth, GA (US)

(73) Assignee: University of Tennessee Research Foundation, Knoxville, TN (US)

(21) Appl. No.: 18/695,866

(22) PCT Filed: Sep. 27, 2022
(86) PCT No.: PCT/US2022/044942

§ 371 Date: Mar. 27, 2024

Related U.S. Application Data
(60) Provisional application No. 63/248,811, filed on Sep. 27, 2021.

(51) Int. Cl. B01D 39/18; B01D 35/06

(52) U.S. Cl. CPC B01D 39/18; B01D 35/06; B01D 2239/0435; B01D 2239/0618; B01D 2239/0636; B01D 2239/065; B01D 2275/10

(57) ABSTRACT

Filter media comprising cellulose fibers and fibrillated thermoplastic fibers, such as fibrillated polyolefins are described. The filter media can be provided in the form of non-woven fiber mats (e.g., wet-laid non-woven fiber mats) that can be integrated into air filtration devices to enhance their biodegradability. The non-woven fiber mats can be prepared as electrets. Composites comprising multiple layers of the same or different filter media can be prepared. Composites having minimum efficiency reporting value (MERV) ratings of at least 12 or at least 13 are described.

### CROSS-REFERENCE TO RELATED APPLICATIONS

This application claims benefit of and priority to U.S. Provisional Patent Application Ser. No. 63/248,811, filed Sep. 27, 2021, the contents of which are incorporated by reference herein in their entirety.

### TECHNICAL FIELD

The presently disclosed subject matter relates to biodegradable filter media comprising cellulose fibers and fibrillated thermoplastic fibers, as well as to related non-woven mats and air filtration devices.

### ABBREVIATIONS

%=percentage
° C.=degrees Celsius
μm=micrometers (or microns)
ASHRAE=American Society of Heating, Refrigerating and Air-Conditioning Engineers
cm=centimeters
CSF=Canadian Standard Freeness
dtex=denier
ESD=electrostatic dissipative
FPM=feet per minute
gm=grams
gsm=grams per square meter
HVAC=heating, ventilation and air conditioning
HW=hardwood
KCl=potassium chloride
MERV=minimum efficiency reporting value
min=minutes
mm=millimeters
MPPS=most penetrating particle size
NMMO=N-methylmorpholine-N-oxide
Pa=pascal
s=seconds
SR=Schopper Riegler
SW=softwood
WF=Williams freeness
WG=water gauge
wt=weight

### BACKGROUND

Air filters are widely used in various applications, including, for example, in heating, ventilation and air conditioning (HVAC) systems in both residential and non-residential buildings, as well as in vehicles (e.g., airplane cabins); in vacuum cleaner bags, in air filters for engines, and in respirators. Air filters can be used in these applications to reduce the number of small particles in the air, such as dust, pet dander, mold spores, microscopic allergens, outdoor pollution particles, smoke, and airborne bacterial and viral particles. In addition, filter media is used to produce face masks, both for medical and industrial workers, and for personal use. Particularly with the increasing use of protective face masks and other air filtration devices to prevent the spread of airborne diseases, such as COVID-19, there is a simultaneous increase in waste from used face masks and air filters.

Accordingly, there is an ongoing need for filtration media that is more environmentally friendly, including filtration media containing a higher proportion of sustainable materials and/or that is more biodegradable, but which still maintains good filtration efficiency.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, the presently disclosed subject matter provides a biodegradable filter media comprising cellulose fibers and fibrillated thermoplastic fibers. In some embodiments, the cellulose fibers comprise hardwood fibers, softwood fibers, fibrillated cellulose fibers, or any combination thereof. In some embodiments, the fibrillated thermoplastic fibers comprise fibrillated polyolefin fibers, optionally wherein the fibrillated polyolefin fibers comprise polyethylene fibers, polypropylene fibers, or a blend thereof.

In some embodiments, the filter media further comprises a cationic polymer. In some embodiments, the cationic polymer comprises polyacrylamide.

In some embodiments, the biodegradable filter media comprises: (a) about 40 weight percent (wt %) to about 70 wt % hardwood fibers, optionally about 55 wt % to about 70 wt % hardwood fibers, on the basis of total fiber weight in the media; (b) about 0 wt % to about 30 wt % softwood fibers, optionally about 20 wt % to about 30 wt % softwood fibers, on the basis of total fiber weight in the media; (c) about 0.5 wt % to about 15 wt % fibrillated thermoplastic fibers, optionally about 5 wt % to about 10 wt % fibrillated thermoplastic fibers, on the basis of total fiber weight in the media; (d) about 0 wt % to about 30 wt % fibrillated cellulose fibers, optionally about 1 wt % to about 2 wt % fibrillated cellulose fibers, on the basis of total fiber weight in the media; and (e) about 0.5 parts to about 1.5 parts of cationic polymer, optionally about 0.75 parts of cationic polymer, per every 100 parts of fiber.

In some embodiments, the hardwood fibers and/or the softwood fibers comprise refined fibers. In some embodiments, the biodegradable filter media further comprises a binder/sizing agent, optionally wherein the binder/sizing agent comprises bio-based, biodegradable polymeric particles and/or wherein the biodegradable filter media comprises between about 5 wt % and about 35 wt % of the binder/sizing agent, further optionally wherein the binder/sizing agent comprises starch nanoparticles.

In some embodiments, the fibrous web is in the form of a non-woven mat. In some embodiments, the non-woven mat is a wet-laid mat, optionally wherein the thermoplastic fibers have a lower softening temperature than a temperature used to dry cellulose fibers in the mat.

In some embodiments, the non-woven mat is an electret, optionally, wherein the electret is prepared by passing the non-woven mat through an electric field between two metallic electrodes, via injection of charge carriers, corona discharge, or a combination thereof.

In some embodiments, the presently disclosed subject matter provides a multilayer filter media comprising a plurality of layers, wherein each of said layers comprises a porous substrate and wherein at least one of said layers comprises a biodegradable filter media comprising cellulose fibers and fibrillated thermoplastic fibers. In some embodiments, the presently disclosed subject matter provides a multilayer filter media comprising a plurality of layers, wherein at least two of said plurality of layers comprises a biodegradable filter media comprising cellulose fibers and fibrillated thermoplastic fibers.

In some embodiments, the plurality of layers comprises, from top to bottom: (i) a first outer non-woven mat comprising or consisting of fibrillated cellulose fibers, optionally consisting of 100 wt % fibrillated cellulose fibers; (ii) at least four interior non-woven mats, wherein each of the at least four interior non-woven mats is the same or different and comprises about 40 wt % to about 70 wt % refined hardwood fibers, about 0 wt % to about 30 wt % refined softwood fibers, about 0.5 wt % to about 15 wt % fibrillated thermoplastic fibers; about 0 wt % to about 30 wt % fibrillated cellulose fibers; and about 0.5 parts to about 1.5 parts of cationic polymer; and (iii) a second outer non-woven mat comprising or consisting of fibrillated cellulose fibers, optionally consisting of 100 wt % fibrillated cellulose fibers.

In some embodiments, the multilayer filter media has a minimum efficiency reporting value (MERV) rating of at least 12. In some embodiments, the multilayer filter media has a MERV rating of at least 13.

In some embodiments, the presently disclosed subject matter provides a method of filtering a stream of flowing air, the method comprising passing the stream of flowing air through a biodegradable filter media comprising cellulose fibers and fibrillated thermoplastic fibers.

In some embodiments, the presently disclosed subject matter provides a method of preparing a biodegradable filter media, the method comprising: (i) providing a fiber mixture, wherein the fiber mixture comprises cellulose fibers and fibrillated thermoplastic fibers; (ii) forming a nonwoven mat from the fiber mixture; and (iii) drying the nonwoven mat, thereby providing the biodegradable filter media. In some embodiments, step (iii) comprises removing excess water under vacuum and drying the nonwoven mat in an oven. In some embodiments, the method further comprises preparing an electret from the nonwoven fiber by passing the nonwoven mat through an electric field; injecting charge carriers; and/or by corona discharge.

In some embodiments, the presently disclosed subject matter provides a biodegradable filter media comprising cellulose fibers, fibrillated thermoplastic fibers, and starch nanoparticles.

Accordingly, it is an object of the presently disclosed subject matter to provide biodegradable filter media, related multilayer filter media, and related methods. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description, Drawings and Examples.

### BRIEF DESCRIPTION OF THE FIGURES

FIG. 1A is a micrograph image of natural cellulose pulp fibers.

FIG. 1B is a micrograph image of fibrillated lyocell, i.e., a regenerated cellulose fiber made from wood pulp.

FIG. 1C is a micrograph image of polyolefin fibers.

FIG. 1D is a micrograph image of fibrillated, high density polyolefin fibers sold under the tradename FYBREL™ (Mitsui Chemicals, Inc., Tokyo, Japan).

FIG. 2 is a pair of schematic diagrams showing hydrogen bonding between cellulose fibers.

FIG. 3 is a schematic diagram showing a typical papermaking process.

FIG. 4 is a series of photographic images showing (left) softwood and hardwood pulp following soaking and the same softwood (bottom right) and hardwood (top right) materials after the pulp was dispersed in a solution using a propeller mixer to break cellulose lumps.

FIG. 5 is a series of photographic images showing an exemplary wet-laid process for preparing non-woven mats of the presently disclosed subject matter.

FIG. 6A is a graph showing particle removal efficiency (as a percentage) versus particle size (in micrometers (μm)) curve for a cellulose-based sample comprising two layers of a non-woven mat comprising, based on the total weight of fiber, 45 weight percent (wt %) hardwood (HW), 30 wt % regenerated cellulose (6 millimeter (mm)), 25 wt % fibrillated polyolefin, and further comprising an add-on binder comprising starch nanoparticles (referred to as Sample 6.1A in the Examples). The most penetrating particle size for this sample was determined as 0.2329 μm.

FIG. 6B is a graph showing particle removal efficiency (as a percentage) versus particle size (in micrometers (μm)) curve for a cellulose-based sample comprising four layers of a non-woven mat comprising, based on the total weight of fiber, 45 weight percent (wt %) hardwood (HW), 30 wt % regenerated cellulose (6 millimeter (mm)), 25 wt % fibrillated polyolefin, and further comprising an add-on binder comprising starch nanoparticles (referred to as Sample 6.1B in the Examples). The most penetrating particle size for this sample was determined as 0.1134 μm.

FIG. 7 is a graph showing particle removal efficiency (as a percentage) versus particle size (in micrometers (μm)) curve for a cellulose-based sample comprising four layers of a non-woven mat each comprising, based on the total weight of fiber in the mat, 55 weight percent (wt %) hardwood (HW), 30 wt % regenerated cellulose (6 millimeter (mm)), and 15 wt % fibrillated polyolefin (referred to as Sample 3A in the Examples).

FIG. 8 is a graph showing particle removal efficiency (as a percentage) versus particle size (in micrometers (μm)) curve for a cellulose-based sample comprising four layers of a non-woven mat each comprising, based on the total weight of fiber in the mat, 45 weight percent (wt %) refined hardwood (HW), 30 wt % refined softwood (SW), 25 wt % fibrillated polyolefin and further comprising an add-on binder comprising starch nanoparticles (referred to as Sample 6.1R in the Examples).

FIG. 9 is a graph showing particle removal efficiency (as a percentage) versus particle size (in micrometers (μm)) curve for a cellulose-based sample comprising four layers of a non-woven mat each comprising, based on the total weight of fiber in the mat, 55 weight percent (wt %) refined hardwood (HW), 30 wt % refined softwood (SW) and 15 wt % fibrillated polyolefin (referred to as Sample 3R in the Examples).

FIG. 10 is a graph showing particle removal efficiency (as a percentage) versus particle size (in micrometers (μm)) curve for a cellulose-based sample comprising one layer of a non-woven mat comprising, based on the total weight of fiber in the mat, 100 weight percent (wt %) 4 millimeter (mm) regenerated cellulose fibers (referred to as Sample Lyo4 in the Examples).

FIG. 11 is a graph showing particle removal efficiency (as a percentage) versus particle size (in micrometers (μm)) curve for a cellulose-based sample comprising one layer of a non-woven mat comprising, based on the total weight of fiber in the mat, 100 weight percent (wt %) 6 millimeter (mm) regenerated cellulose fibers (referred to as Sample Lyo6 in the Examples).

FIG. 12 is a graph showing particle removal efficiency (as a percentage) versus particle size (in micrometers (μm)) curve for a cellulose-based sample comprising 1 layer of a non-woven mat described for FIG. 11 and the 4 layers of non-woven mat described for FIG. 8.

FIG. 13 is a graph showing particle removal efficiency (as a percentage) versus particle size (in micrometers (μm)) curve for a sample comprising a sandwich comprising: 1 layer of a non-woven mat as described for FIG. 11, the 4 layers of non-woven mat as described for FIG. 8, and 1 additional layer of a non-woven mat as described for FIG. 11.

FIG. 14 is a graph showing particle removal efficiency (as a percentage) versus particle size (in micrometers (μm)) curve for a sample comprising a sandwich comprising: 1 layer of a non-woven mat as described for FIG. 11, 1 layer of a non-woven mat having a fiber content as described for the mats or FIG. 9, the 4 layers of non-woven mat as described for FIGS. 8, and 1 additional layer of a non-woven mat as described for FIG. 11.

FIG. 15 is a graph showing particle removal efficiency (as a percentage) versus particle size (in micrometers (μm)) curve for a sample comprising a sandwich comprising: 1 layer of a non-woven mat as described for FIG. 11, two layers of non-woven mat having a fiber content as described for the mats of FIG. 9, the 4 layers of non-woven mat as described for FIGS. 8, and 1 additional layer of a non-woven mat as described for FIG. 11.

FIG. 16A is a graph showing the air velocity (in feet per minute (FPM)) versus resistance (in inches water gauge (“WG)) for one layer of a non-woven mat comprising meltblown thermoplastic fibers.

FIG. 16B is a graph showing the air velocity (in feet per minute (FPM)) versus resistance (in inches water gauge (“WG)) for four layers of non-woven mat comprising meltblown thermoplastic fibers.

FIG. 16C is a graph showing the air velocity (in feet per minute (FPM)) versus resistance (in inches water gauge (“WG)) for two layers of a mat comprising, on the basis of total fiber content, 45 weight percent (wt %) hardwood (HW), 30 wt % regenerated cellulose (6 millimeter (mm)), 25 wt % fibrillated polyolefin, and further comprising an add-on binder comprising starch nanoparticles (referred to as Sample 6.1A in the Examples).

FIG. 16D is a graph showing the air velocity (in feet per minute (FPM)) versus resistance (in inches water gauge (“WG)) for four layers of a non-woven mat comprising, based on the total weight of fiber in the mat, 45 weight percent (wt %) hardwood (HW), 30 wt % regenerated cellulose (6 millimeter (mm)), 25 wt % fibrillated polyolefin, and further comprising an add-on binder comprising starch nanoparticles (referred to as Sample 6.1B in the Examples).

FIG. 16E is a graph showing the air velocity (in feet per minute (FPM)) versus resistance (in inches water gauge (“WG)) for four layers of a non-woven mat comprising, based on the total weight of fiber in the mat, 45 weight percent (wt %) refined hardwood (HW), 30 wt % refined softwood (SW), 25 wt % fibrillated polyolefin and further comprising an add-on binder comprising starch nanoparticles (referred to as Sample 6.1R in the Examples).

FIG. 16F is a graph showing the air velocity (in feet per minute (FPM)) versus resistance (in inches water gauge (“WG)) for four layers of a non-woven mat comprising, based on the total weight of fiber in the mat, 55 weight percent (wt %) hardwood (HW), 30 wt % regenerated cellulose (6 millimeter (mm)), and 15 wt % fibrillated polyolefin (referred to as Sample 3A in the Examples).

FIG. 16G is a graph showing the air velocity (in feet per minute (FPM)) versus resistance (in inches water gauge (“WG)) for four layers of a non-woven mat comprising, based on the total weight of fiber in the mat, 55 weight percent (wt %) refined hardwood (HW), 30 wt % refined softwood (SW) and 15 wt % fibrillated polyolefin (referred to as Sample 3R in the Examples).

FIG. 16H is a graph showing the air velocity (in feet per minute (FPM)) versus resistance (in inches water gauge (“WG)) for one layer of a non-woven mat comprising, based on the total weight of fiber in the mat, 100 percent (wt %) 4 millimeter (mm) regenerated cellulose fibers (referred to as Sample Lyo4 in the Examples).

FIG. 16I is a graph showing the air velocity (in feet per minute (FPM)) versus resistance (in inches water gauge (“WG)) for one layer of a non-woven mat comprising, based on the total weight of fiber in the mat, 100 weight percent (wt %) 6 millimeter (mm) regenerated cellulose fibers (referred to as Sample Lyo6 in the Examples).

FIG. 16J is a graph showing the air velocity (in feet per minute (FPM)) versus resistance (in inches water gauge (“WG)) for a composite comprising the single layer non-woven mat as described in FIG. 16I and the four non-woven mat layers described for FIG. 16E.

FIG. 16K is a graph showing the air velocity (in feet per minute (FPM)) versus resistance (in inches water gauge (“WG)) for a composite comprising a top layer of the single layer non-woven mat described for FIG. 16I, the four non-woven mat layers described for FIG. 16E, and a bottom layer comprising another single layer as described for FIG. 16I.

FIG. 16L is a graph showing the air velocity (in feet per minute (FPM)) versus resistance (in inches water gauge (“WG)) for a composite comprising a top layer of the single non-woven mat layer as described for FIG. 16I; an inner layer comprising a non-woven mat comprising, based on the total weight of fiber in the mat, 30 weight percent (wt %) refined softwood, 55 wt % refined hardwood, and 15 wt % fibrillated polyolefin; four inner layers comprising the four non-woven mat layers described for FIG. 16E, and a bottom layer comprising a single non-woven mat layer as described for FIG. 16I.

FIG. 16M is a graph showing the air velocity (in feet per minute (FPM)) versus resistance (in inches water gauge (“WG)) for a composite comprising a top layer of comprising a single non-woven mat layer as described for FIG. 16I; two inner layers of non-woven mat comprising, based on the total weight of fiber in the mat, 30 weight percent (wt %) refined softwood, 55 wt % refined hardwood, and 15 wt % fibrillated polyolefin; four inner layers comprising the four non-woven mat layers described for FIG. 16E, and a bottom layer comprising a single non-woven mat as described for FIG. 16I.

FIG. 17 is a schematic drawing showing a cross-sectional view of an exemplary multilayer filter media of the presently disclosed subject matter.

FIG. 18A is a scanning electron microscope (SEM) image of fibers in a three layer composite where each layer comprises, based on the total weight of fiber in the layer, 45 weight percent (wt %) hardwood fibers, 30 wt % 6 millimeter (mm) regenerated cellulose fibers, and 25 wt % fibrillated polyolefin fibers, and further comprising an add on binder comprising starch nanoparticles.

FIG. 18B is a scanning electron microscope (SEM) image of fibers from a composite having the same composition as that described in FIG. 18A after the composite was buried in moist soil at a depth of six inches for four days.

FIG. 18C is a scanning electron microscope (SEM) image of fibers from a composite having the same composition as that described in FIG. 18A after the composite was buried in moist soil at a depth of six inches for seven days.

### DETAILED DESCRIPTION

The presently disclosed subject matter relates, in some embodiments, to fiber-containing compositions with high bio-content (e.g., high content of cellulose based fibers) that can be used as biodegradable filter media, e.g., for filtering air. In some embodiments, the fiber-containing compositions comprise biodegradable fibers and optionally other biodegradable components. For example, the compositions can be prepared as biodegradable filter media that can be integrated into or used (singly or in combinations of multiple layers of mat) as air filters. In some embodiments, the presently disclosed subject matter relates to a biodegradable filter media comprising cellulosic fibers (virgin and/or regenerated cellulosic fibers) and synthetic fibers (e.g., synthetic thermoplastic fibers, such as polyethylene, polypropylene or blends thereof). In some embodiments, the presently disclosed biodegradable filter media can be provided in the form of a non-woven fiber mat, such as a non-woven mat prepared via a wet-laid process using fibers of various lengths, diameter, and characteristics including fibrillated fibers. Such structures can provide control of pore structure as well as reinforcement. The presently disclosed fiber mat or other filter media can be further enhanced in filtration properties and structurally reinforced by impregnation with a dispersion comprising a binder/sizing agent comprising biodegradable polymer(s) with or without components such as electrostatic dissipative (ESD) polymers.

In some embodiments, the presently disclosed biodegradable filter media can be used as a pre-filter ahead of non-biodegradable filter materials, such as N95 or related filter materials. In some embodiments, the presently disclosed subject matter provides a multilayer composite comprising a plurality of layers of biodegradable filter media.

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, light output, atomic (at) or mole (mol) percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or +10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, a “monomer” refers to a non-polymeric molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

As used herein the terms “polymer”, “polymeric” and “polymeric matrix” refer to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units. A “copolymer” refers to a polymer derived from more than one species of monomer.

The term “thermoplastic” can refer to a polymer that softens and/or can be molded above a certain temperature, but which is solid below that temperature. Thermoplastic polymers include, but are not limited to, ethylene vinyl acetate copolymers (EVA), polyolefins (e.g., polyethylene, polypropylene (PP), polyamides, some polyesters (e.g., polybutylene terephthalate (PBT)), styrene block copolymers (SBCs), polycarbonates, silicone rubbers, fluoropolymers, thermoplastic elastomers, polypyrrole, polycaprolactone, polyoxymethylene (POM), and mixtures and/or combinations thereof.

The term “polyolefin” refers to a polymer or co-polymer prepared from an alkene monomer or a mixture of alkene monomers. Exemplary polyolefins include, but are not limited to, polyethylene, polypropylene, polybutene, polymethylpentene, and copolymers of ethylene and alpha-olefins such as 1-hexene and 1-octene.

“Biodegradable” means materials that are broken down or decomposed by natural biological processes. Biodegradable materials can be broken down for example, by cellular machinery, proteins, enzymes, hydrolyzing chemicals or reducing agents present in biological fluids or soil, intracellular constituents, and the like, into components that can be either reused or disposed of without significant toxic effect on the environment. Thus, the term “biodegradable” as used herein refers to both enzymatic and non-enzymatic breakdown or degradation of polymeric structures. In some embodiments, the degradation time is a function of polymer composition and morphology. Suitable degradation times are from hours or days to weeks to years.

The term “hydrophilic” can refer to a chemical group or material that can form attractive interactions (e.g., hydrogen bonding interactions) with water and/or aqueous solutions and thus be “wetted” by water and/or aqueous solutions.

As used herein, the term “filter media” refers to a web of fibers, e.g., entangled fibers. The fiber web provides a porous structure (e.g., a complex torturous porous structure) that permits a liquid or gas (e.g., air) to flow through the filter media. Contaminants (e.g., contaminant particles, such as dust or virus particles) contained within the liquid or gas can be trapped on the fibrous web. Filter media characteristics, such as fiber composition, diameter and basis weight, can affect filter performance, including filter efficiency, dust holding capacity and resistance to fluid/gas flow through the filter. Filter media be provided in forms such as, but not limited to, non-woven mats, papers, woven mats, fabrics, and the liked. The filter media can comprise a single layer (e.g., a single non-woven mat) or multiple layers (e.g., multiple non-woven mats layered sequentially). Multilayer filter media (also referred to herein as “composites”) can include multiple layers having the same composition (e.g., the same types and ratios of fibers and other media components) or can include layers whose composition differs from other layers in the multilayer media. Multilayer media can include two, three, four, five, six, seven, eight, nine, ten, or more layers.

The filter media described herein can include “fibrillated” fibers (e.g., fibrillated lyocell fibers or other regenerated cellulose fibers and/or fibrillated synthetic fibers, such as, but not limited to polyolefin or other thermoplastic fibers). As understood by those of ordinary skill in the art, a fibrillated fiber includes a parent fiber that branches into smaller diameter fibrils which can, in some instances, branch further out into even smaller diameter fibrils with further branching also being possible. The branched nature of the fibrils leads to a high fiber surface area and can increase the number of contact points between the fibrillated fibers and other fibers in the web. In some embodiments, this increase in points of contact between the fibrillated fibers and the glass fibers contributes to enhancing the mechanical properties (e.g., flexibility, strength) of the web.

Fibrillated fibers can include any suitable level of fibrillation. The level of fibrillation relates to the extent of branching in the fiber. The level of fibrillation can be measured according to several suitable methods. For example, the level of fibrillation can be measured according to a Canadian Standard Freeness (CSF) test, specified by TAPPI test method T 227 om 09 Freeness of pulp. In some embodiments, the average CSF value for the fibrillated fibers can be about 20 or greater. For example, the average CSF value can be between 100 and 850, between about 150 and about 750, or between about 300 and about 750 (e.g., about 300, 325, 350, 375, 400, 425, 450, 475, 500, 525, 550, 575, 600, 625, 650, 675, 700, 725, or about 750). However, in some embodiments, the CSF can be lower, e.g., between about 20 and 30. In some embodiments, the level of fibrillation can be measured according to a Schopper Riegler (SR) test. In some embodiments, the average SR value for the fibrillated fibers can be greater than about 20. For example, the average SR value can be between about 20 and about 80. In some embodiments, the level of fibrillation can be measured according to a Williams Freeness (WF) test. In some embodiments, the average WF value for the fibrillated fibers can be greater than about 150. For example, the average WR values for the fibrillated fibers can be between about 150 and about 700.

In some embodiments, the fibrillated fibers of the presently disclosed filter media are formed of lyocell. Lyocell fibers are regenerated cellulose fibers made from wood pulp. Lyocell fibers can be resistant to high temperature, further providing the filter media with an increased resistance to high temperatures. Suitable lyocell fibers can be obtained and are commercially available (e.g., from Lenzing AG, Lenzing Austria), for example, in an un-fibrillated or fibrillated state. Lyocell fibers can be manufactured, in some embodiments, through spinning in a non-water-based environment (e.g., amine oxide). In some embodiments, the lyocell can be manufactured by dissolving wood pulp and/or cellulose fibers therefrom in a solution of hot N-methylmorpholine-N-oxide (NMMO), a cyclic amine oxide, and spun into fibers. The fibers can be fibrillated through any appropriate fibrillation refinement process. In some embodiments, fibers (e.g., lyocell fibers) are fibrillated using a disc refiner, a stock beater or any other suitable fibrillating equipment.

The fibrillated fibers can have any suitable dimensions. As noted above, fibrillated fibers include parent fibers and fibrils. The parent fibers can have an average diameter of less than about 75 microns; in some embodiments, less than about 60 microns; and in some embodiments, less than about 15 microns. The fibrils can have an average diameter of less than about 15 microns; in some embodiments, less than about 10 microns; in some embodiments, less than about 6 microns; in some embodiments, less than about 4 microns; in some embodiments, less than about 3 microns; and in some embodiments, less than about 1 micron. For example, the fibrils can have a diameter of between about 3 microns and about 10 microns, or between about 3 microns and about 6 microns. The fibrillated fibers can have an average length of less than about 15 mm. For example, the average length can be between about 0.2 and about 12 mm, or between about 2 mm and about 4 mm. The above-noted dimensions can be, for example, when the fibrillated fibers are lyocell.

“Furnish” and like terminology refers to aqueous compositions including fibers and other media components (e.g., cationic polymers) that can be used in the preparation of filter media, such as nonwoven mats and papers. The term “slurry” as used herein refers to a dispersion of fibers (e.g., an aqueous dispersion of fibers). In some embodiments, the terms “furnish” and “slurry” can be used interchangeably.

The term “electret” as used herein refers to a stable dielectric material (e.g. an electret fiber or a nonwoven fibrous web comprising electret fibers) with a quasi-permanently embedded static electric charge and/or a quasi-permanently oriented dipole polarization. Electret materials of the presently disclosed subject matter can be used to make a variety of products and/or articles.

The terms “nonwoven fibrous web” and “nonwoven fiber mat” as used herein refer to an article or sheet having a structure of individual fibers and/or fibrils, which are interlaid, but not in an identifiable manner as in a knitted fabric. Nonwoven webs include, for example, meltblown webs, spunbond webs, carded webs, wet-laid webs, airlaid webs, coform webs, hydraulically entangled webs, etc. Fibers forming the webs or fabrics can have geometric, non-geometric and/or irregular shapes. In some embodiments, the nonwoven fiber mat of the presently disclosed subject matter is a wet-laid web.

The term “calendaring” as used herein refers to a process of passing a fibrous web (e.g., a nonwoven fibrous web) through rollers with application of pressure to obtain a compressed and bonded fibrous web. The rollers can optionally be heated.

The term “porosity” refers to a measure of void spaces in a material. Size, frequency, number, and/or interconnectivity of pores and voids contribute the porosity of a material.

The term “synthetic” as used herein refers to materials that are non-naturally occurring. In some embodiments, the term “synthetic” refers to materials derived from petroleum-based precursors.

### II. Filter Media

The presently disclosed subject matter relates to filter media that is biodegradable and has high bio-content. In some embodiments, the presently disclosed filter media comprises cellulose fibers (which can be virgin cellulose fibers or recycled cellulose fibers) and synthetic thermoplastic fibers. In some embodiments, the cellulose fibers are derived from hardwood and/or softwood cellulosic pulp. In some embodiments, the filter media comprise both non-fibrillated and fibrillated fibers. For instance, in some embodiments, some or all of the thermoplastic fibers are fibrillated.

More particularly, in some embodiments, the cellulose fibers comprise at least 50 weight % (wt %) of the fiber content of the filter media (e.g., at least 50, 55, 60, 65, 70, 75, 80, 85, 90, or 95 wt % or more of the fiber content). The cellulose fibers can include one or both of softwood-derived (e.g., Southern softwood-derived) fibers and hardwood-derived fibers. Hardwood fibers can be useful in providing a desired pore structure and/or torturous path to achieve a desired filtration efficiency. Softwood fibers can be used to provide the filter media with dry strength and desired plat characteristics. In some embodiments, some or all of the non-fibrillated cellulose fibers in the filter media are derived from unrefined pulp or from a normally refined pulp and can have any desired freeness level.

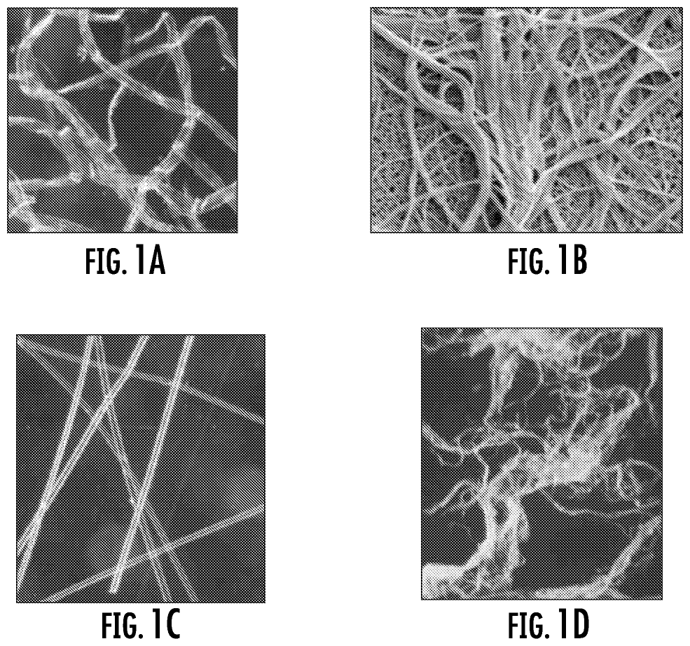

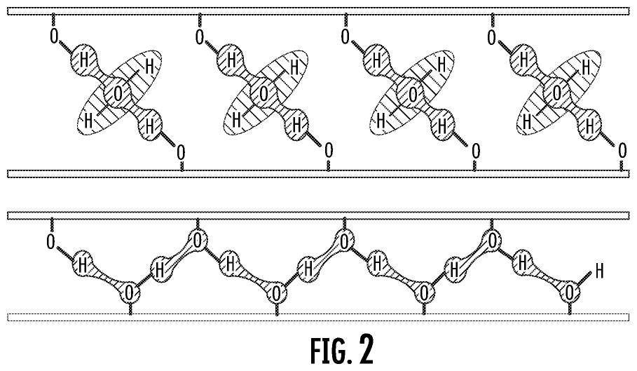

In some embodiments, at least a portion of the cellulose fibers are regenerated cellulose fibers. For instance, lyocell is a regenerated cellulose fiber commercially available from Lenzing (Lenzing AG, Lenzing, Austria) in both non-fibrillated and fibrillated forms. Lyocell can be used to provide wet/dry tensile strength during manufacturing of the presently disclosed filter media and in the final product. Non-fibrillated lyocell can include products with a 4-6 mm length and a linear mass density of about 1.7 denier (dtex). In some embodiments, the lyocell can be fibrillated. Exemplary fibrillated lyocell can have a SR value of about 68 (e.g., CSF of between about 100-120) or about 80 (e.g., CSF of between about 20-30). Differences in structure between natural pulp fibers and fibrillated lyocell fibers can be seen in FIGS. 1A and 1B, while FIG. 2 shows different types of hydrogen bonding that can occur between hydroxyl groups on the surface of cellulose-based fibers.

In some embodiments, the thermoplastic fibers can have a softening temperature that is lower than the drying temperature used to dry the cellulose fibers in any formed filter media. In some embodiments, the thermoplastic fibers can have a melting temperature of about 150° C. or less, about 140° C. or less, about 135° or less, about 130° C. or less, or about 125° C. or less. In some embodiments, the thermoplastic fibers can have a softening temperature of about 133° C. or less.

In some embodiments, the thermoplastic fibers are polyolefin fibers. In some embodiments, the polyolefin fibers are fibrillated. Suitable fibrillated polyolefin fibers include fibrillated polyethylene fibers, fibrillated polypropylene fibers, and blends thereof. The use of high-density fibrillated polyolefin fibers can provide electret properties of the final filter media product. In addition, their large surface area supports efficient particle trapping, while their low bulk density can support uniform dispersion. High density fibrillated polyolefin fibers can also be hydrophilic enough to provide uniform integration and compounding with particles and cellulose. Suitable high-density, fibrillated polyolefin fibers for use in the presently disclosed filter media are commercially available, for example, under the tradename FYBREL™ (Mitsui Chemicals, Inc., Tokyo, Japan), which have melting points between about 100 and about 135° C. Suitable FYBREL™ fibers include, but are not limited to, those sold under the product codes ESS2, ESS5, EST8, E380, E400, E620, E790, E990, AU690, and NL491. EST8, for example, has an average fiber length of about 0.43-0.67 mm, a fiber diameter of about 5 microns, an average surface area of about 10 m²/gm, and an average SCF of about 540, while E400 has an average fiber length of about 0.46-0.68 mm, a fiber diameter of about 15 microns, an average surface area of about 8, and an average CSF of about 580. Differences in structure between non-fibrillated polyolefin fibers and fibrillated polyolefin fibers can be seen in FIGS. 1C and 1D.

Cellulose fibers, including hardwood, softwood, and lyocell fibers, have an anionic charge. In some embodiments, e.g., to improve retention of these fibers, a diluted solution of a high molecular weight cationic polymer can be added to the fiber slurry used to prepare the filter media. In some embodiments, the cationic polymer can serve as a bridge between fibrillated fibers (e.g., fibrillated cellulose and/or polyolefin fibers) and cellulose fibers. Cationic polymers are known in the field of paper making as retention/drainage/clarification aids. Exemplary cationic polymers include, but are not limited to, cationic starch, polyelectrolyte, derivatized cationic guar gum, and polyacrylamide (e.g., cationic polyacrylamide). For example, in some embodiments, the cationic polymer is a polyacrylamide, such as the polyacrylamide sold under the tradename PERFORM™ PC8134F (Solenis, Wilmington, Delaware, United States of America). The polyacrylamide polymer can be added to a slurry of fiber at an amount of about 0.5 to about 1.5 parts per 100-1000 parts of fiber. If additional retention is desirable, this amount can be increased.

Accordingly, in some embodiments, the presently disclosed subject matter provides a biodegradable filter media comprising:
(a) about 40 wt % to about 70 wt % hardwood fibers (e.g., about 40, 45, 50, 55, 60, 65, or about 70 wt % hardwood fibers) on the basis of total fiber weight;
(b) about 0 wt % to about 30 wt % softwood fibers (e.g., about 0, 5, 10, 15, 20, 25, or about 30 wt % softwood fibers) on the basis of total fiber weight;
(c) about 0.5 wt % to about 15 wt % fibrillated thermoplastic fibers (e.g., about 0.5, 1, 1.5, 2, 2.5, 5, 7.5, 10, 12.5, or about 15 wt % fibrillated thermoplastic fibers) on the basis of total fiber weight;
(d) about 0 wt % to about 30 wt % fibrillated cellulose fibers (e.g., about 0, 5, 10, 15, 20, 25, or about 30 wt % fibrillated cellulose fibers) on the basis of total fiber weight; and
(e) about 0.5 parts to about 1.5 parts of a binder, such as a cationic polymer (e.g., about 0.75 parts of cationic polymer), for every 100 parts of fiber.

In some embodiments, the filter media comprises about 55 wt % to about 70 wt % of hardwood cellulose fibers on the basis of total fiber weight. In some embodiments, the filter media comprises about 20 wt % to about 30 wt % softwood cellulose fibers on the basis of total fiber weight. In some embodiments, the filter media comprises about 5 wt % to about 10 wt % of fibrillated thermoplastic (e.g., polyolefin) fibers on the basis of total fiber weight. In some embodiments, the filter media comprises between about 1 wt % to about 2 wt % fibrillated cellulose fibers on the basis of total fiber weight.

In some embodiments, the filter media further comprises a binding agent/sizing agent that can provide electret properties and/or increase filtration efficiency. In some embodiments, the binding agent/sizing agent comprises bio-based, biodegradable polymeric particles. In some embodiments, the polymeric particles comprise starch and are produced from a bio-mass material (e.g., corn). Suitable binder/sizing agents for use according to the presently disclosed subject matter include the dispersions of starch nanoparticles sold under the tradenames ECOSPHERE™ and BIOLATEX BINDER™ (EcoSynthetix, Ltd., Burlington, Canada). In some embodiments, these nanoparticles can have an average diameter between about 20 nanometers (nm) and about 150 nm (e.g., 20, 30, 40, 50, 60, 70, 80, 90, 100, 110, 120, 130, 140, or about 150 nm). In some embodiments, the filter media comprises between about 5 wt % to about 35 wt % (e.g., about 5 wt %, about 10 wt %, about 15 wt %, about 20 wt %, about 25 wt %, about 30 wt % or about 35 wt %) of the binder/sizing agent based on the total weight of the filter media (e.g., the dried filter media, such as a dried nonwoven mat). In some embodiments, the binder/sizing agent can be added to the media after a fiber web is formed, e.g., by dipping the fiber web in a bath comprising the binder/sizing agent. In some embodiments, use of the binder (e.g., biodegradable nanoparticles) can be useful in maintaining the integrity (e.g., the structural integrity) of the media during use.

In some embodiments, the binder can include particles with ESD properties. For example, the particles can include particles comprising ESD polymers, including, but not limited to metallocene (e.g., ferrocene)-containing polymers, thermoplastic polymers comprising conductive fillers (e.g., carbon black and/or metallic fillers), polymers comprising quaternary amines, and polymers comprising dispersive polymeric or oligomeric groups, such as ethylene oxide-based copolymers. The ESD polymers can be polymers such as those described in, for example, U.S. Pat. Nos. 6,140,405; 6,284,839, and 7,041,374, the disclosures of which are each incorporated herein by reference in their entireties.

In some embodiments, the hardwood and/or softwood fiber is unrefined. Unrefined northern softwood pulp freeness is typically about 600 CSF to about 640 CSF. Unrefined northern hardwood pulp freeness is typically about 460 CSF to about 540 CSF. Refined pulp will have a lower CSF than its unrefined counterpart. As described hereinbelow, filter media formed with unrefined SW and/or HW pulp typically provides a MERV rating of about 8. In some embodiments, filter media formed with refined SW and/or HW pulp can provide higher filtration efficiency. In some embodiments, filter media formed with refined HW and/or SW fibers can provide a MERV rating of 11 or more. In some embodiments, at least about 50 wt % (e.g., about 50 wt %, about 55 wt %, about 60 wt %, about 65 wt %, about 70 wt %, about 75 wt %, about 80 wt %, about 85 wt %, about 90 wt %, or about 95 wt % or more) of the SW and/or HW fiber is refined. In some embodiments, about 100 wt % of the SW and/or HW fiber is refined.

In some embodiments, the presently disclosed subject matter provides a biodegradable filter media comprising cellulose fibers, fibrillated thermoplastic polymer fibers, and bio-based (e.g., starch) nanoparticles. In some embodiments, the cellulose fibers comprise regenerated and/or fibrillated cellulose fibers. In some embodiments, the cellulose fibers comprise hardwood and/or softwood fibers (e.g., refined hardwood and/or softwood fibers). In some embodiments, the fibrillated thermoplastic fibers are polyethylene fibers. In some embodiments, the bio-based nanoparticles are starch nanoparticles (e.g., having a diameter between about 20 nm and about 150 nm).

In some embodiments, the presently disclosed biodegradable filter media is provided in the form of a non-woven mat. In some embodiments, the non-woven mat can be prepared via a wet-laid process (i.e., is a wet-laid nonwoven mat).

In some embodiments, the non-woven mat or other biodegradable filter media is an electret. For example, the electret can be prepared by passing a non-woven mat (or other filter media) of the presently disclosed subject matter through a strong electric field between two metallic electrodes. Other methods of preparing an electret include injecting charge carriers, corona discharges, and combinations of any of these processes.

In some embodiments, the biodegradable filter media (e.g., the non-woven mat or electret non-woven mat biodegradable filter media) is provided as a filter material for a face mask (e.g., a surgical face mask or a non-surgical face mask). In some embodiments, the biodegradable filter media (e.g., the non-woven mat or electret non-woven mat biodegradable filter media) is provided as a filter material to be mixed (e.g., layered) with another filter medium, such as a thermoplastic filter medium, for a face mask (e.g., a surgical face mask or a non-surgical face mask) to provide a more “eco-friendly” face mask.

In some embodiments, one or more layers of filter media (e.g., one or more layers of non-woven fiber mat) formed with refined cellulose (refined HW pulp, refined SW pulp, or combinations thereof)) can be combined with one or more filter media layers comprising, consisting essentially of, or consisting of fibrillated cellulose fibers (e.g., Lyocell). For example, non-woven mats or other filter media comprising about 100% fibrillated cellulose fibers can be used as one or both of the outer layers of a sandwich or composite filter media structure further comprising 2 or more inner layers (e.g., 2, 3, 4, 5, 6, 7, 8, or more non-woven mat layers). In some embodiments, each of one or more inner layers of the sandwich or composite structure are layers comprising filter media (e.g., non-woven mat filter media) of the presently disclosed subject matter wherein the hardwood and/or softwood fibers comprise or consist of refined fibers. In some embodiments, the sandwich comprises at least four inner layers comprising refined cellulose fibers.

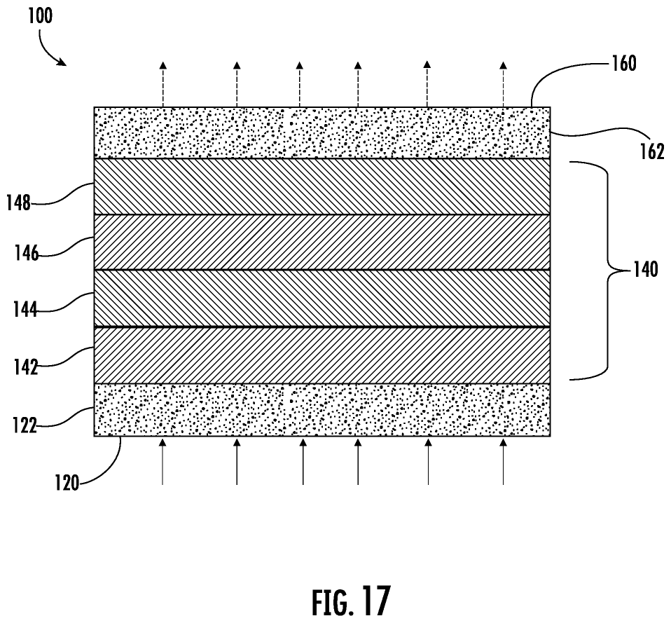

An exemplary multilayer/composite filter media 100 is shown in FIG. 17. For instance, multilayer filter media 100 has first outer surface 120 that can be contacted with a flow of unfiltered air (solid arrows) and a second outer surface 160, from which filtered air (dashed arrows) can exit. First outer surface 120 is an outer surface of outer layer 122, which can be a non-woven mat or other media layer that acts as a “pre-filter” or “non-primary” filter layer. Outer layer 122 can be a layer consisting essentially of a web of regenerated cellulose fibers (e.g., Lyocell). Outer layer 122 is in direct contact with inner “primary” filter 140, which, as shown in FIG. 17, includes four primary filter layers, 142, 144, 146, and 148, each having a composition of a biodegradable filter media as disclosed herein. Thus, each of the primary filter layers has a composition comprising cellulose fibers (fibrillated and/or nonfibrillated hardwood and/or softwood fibers) and fibrillated thermoplastic fibers. The primary filter layers optionally include a cationic polymer (e.g., polyacrylamide). The primary filter layers can further optionally include a binder/sizing agent, such as biodegradable (e.g., starch) nanoparticles. While primary filter 140 of FIG. 17 has four primary filter layers, it can have more layers (e.g., 5, 6, 7, 8, 9 or more layers) or less layers (e.g., one layer, two layers or three layers). The primary filter layers can all have the same composition or at least one layer can have a different composition to one of the other layers. Optionally, and as shown in FIG. 17, multilayer filter media 100 further includes second outer surface layer 162, which can be a second layer of regenerated cellulose (e.g., fibrillated or non-fibrillated Lyocell), on the opposite side of primary filter 140 from layer 122. Alternatively, in the absence of a second layer of regenerated cellulosed, the second outer surface layer can be an outer surface of a primary layer. Further while shown as flat layers in FIG. 17, the layers of multilayer composite 100 can be pleated (e.g., vertically pleated), if desired. In addition, the composite can be provided with a support structure, such as a frame, on the sides of the layers.

Accordingly, in some embodiments, the presently disclosed subject matter provides a multilayer filter media comprising a plurality of layers (e.g., 2, 3, 4, 5, 6, 7, 8, 9, 10, 15, 20, 25, or more layers). In some embodiments, each of the layers comprises a porous substrate, such as a fiber web, and at least one of the layers comprises a biodegradable filter media of the presently disclosed subject matter, i.e., a biodegradable filter media comprising cellulose fibers and fibrillated thermoplastic fibers. In some embodiments, at least two (e.g., 2, 3, 4, 5, 6, 7, 8, 9, 10, or more) of said plurality of layers, comprises a biodegradable filter media of the presently disclosed subject matter. In some embodiments, one or more of the layers is provided as a non-woven mat (e.g., a wet-laid mat). In some embodiments, one or more of the layers comprises an electret.

In some embodiments, the plurality of layers comprises, from top to bottom: (i) a first outer layer (e.g., a first outer non-woven mat) comprising or consisting of cellulose fibers (e.g., fibrillated cellulose fibers); (ii) at least four interior layers (e.g., at least four interior non-woven mats), wherein each of the at least four interior layers is the same or different and comprises, on the basis of total fiber weight in the layer, about 40 wt % to about 70 wt % refined hardwood fibers, about 0 wt % to about 30 wt % refined softwood fibers, about 0.5 wt % to about 15 wt % fibrillated thermoplastic fibers; and about 0 wt % to about 30 wt % fibrillated cellulose fibers; and further comprising about 0.5 parts to about 1.5 parts of cationic polymer per every 100 parts of fiber; and (iii) a second outer layer (e.g., a second non-woven mat) comprising or consisting of cellulose fibers (e.g., fibrillated cellulose fibers). In some embodiments, the first and/or the second outer layer comprises about 100 wt % cellulose fibers (e.g., fibrillated cellulose fibers) based on the total weight of fiber in the layer. In some embodiments, the at least four interior layers comprise at least four layers comprising about 30 wt % refined softwood fibers on the basis of total fiber weight, 45 wt % refined hardwood fibers on the basis of total fiber weight, 25 wt % fibrillated polyolefin (polyethylene) on the basis of total fiber weight and further comprising starch nanoparticles (e.g., about 5 wt % to about 35 wt % starch nanoparticles based on the total weight of the layer). In some embodiments, the at least four interior layers comprise or further comprises one or two layers each comprising, on the basis of total fiber weight, about 30 wt % refined softwood, about 55 wt % refined hardwood and about 15 wt % fibrillated polyolefin (polyethylene).

In some embodiments, the multilayer filter media has a minimum reporting value (MERV) rating of at least about 12. In some embodiments, the multilayer fiber media has a MERV rating of at least about 13.

### III. Applications

The filter media (e.g., electret filter media) of the presently disclosed subject matter can be used to make a variety of products and/or articles. Thus, as used herein the terms “filter” or “filter media” can refer to materials (e.g., fabrics) which provide a desired level of barrier properties and are not limited to the strict or narrow definition of a filter which requires entrapment of particles. Accordingly, the filter media of the presently disclosed subject matter can be used in air and gas filtration media such as, for example, those used in HVAC filters, vacuum cleaner bags, respirators, air filters for engines, air filters for cabin air filtration, heating and/or air conditioner filters, and so forth. Additionally, the filter media of the presently disclosed subject matter can also be utilized in infection control products such as, for example, medically oriented items such as face masks, wound dressings, sterilization wraps and the like. If desired, filters for face masks can be tested using standard testing methods as described, for example, in Procedure No. TEB-APR-STP-0059 (Revision 3.2, Dec. 13, 2019), titled “Determination of Particulate Filter Efficiency Level for N95 Series Filters Against Solid Particulates for Non-powered, Air-purifying Respirators Standard Testing Procedure (STP)” by the National Institute for Occupational Safety and Health (NIOSH). Further, electret filter media of the presently disclosed subject matter can be utilized in hand wipes and other similar applications. In this regard, the electret media can be particularly adept at picking up lint, dust, dust mites, and other fine particulate matter. Polymeric electret materials can comprise or be incorporated as a component within in a wide variety of articles.

In some embodiments, the presently disclosed subject matter can provide a pre-filter in an air filtration application, such as upstream of another filter medium, such as a thermoplastic filter medium, to filter out larger particles and increase the file of the other filter medium, such as a thermoplastic filter medium. The thermoplastic filter medium can be used to filter out smaller particles. The pre-filter can be fitted closely to the thermoplastic filter medium. In some embodiments, the pre-filter and thermoplastic filter medium can be provided in the form of a face mask. The pre-filter arrangement can be implemented in a hospital setting, school setting, or other air filtration system as would be apparent to one of ordinary skill in the art upon a review of the instant disclosure. In some embodiments, the biodegradable filter media of the presently disclosed subject matter can be provided as a filter for a face mask without another filter medium. In some embodiments, the biodegradable filter media can be provided in a vertically pleated form. In some embodiments, the vertically pleated form can have about three times the filtration efficiency as a flat form of the same media. In some embodiments, the media can be disinfected (e.g., using UV radiation, heat, soap and water, alcohol solutions, vapor phase hydrogen peroxide, etc.) and/or reused.

In some embodiments, a biodegradable filter media of the presently disclosed subject matter, or a composite comprising said biodegradable filter media can be provided, optionally in combination with a support material, such as a paper framing, as an air filter, e.g., as a cartridge filter, a pleated filter, or a box filter.

In some embodiments, the presently disclosed subject matter provide a method of filtering a stream of flowing air, wherein the method comprises passing the stream of flowing air through a biodegradable filter media as described herein. In some embodiments, the stream of flowing air is a stream of flowing air in a residential building, a factory, a medical facility, an office building, or a store. In some embodiments, the biodegradable filter media is placed in a return air duct of a HVAC system.

In some embodiments, the filter media can be used to filter dust, dust mites, pet dander, pollen, pollen spores, smoke, smog, lint, bacteria, and/or viruses from air.

In some embodiments, the filter media can be used in an application to act as a filter for protection from coronavirus 2019 (COVID-19). For instance, the filter media can be used in reusable masks and/or filter packaging. The media can be incorporated in to rigid or flexible products (e.g., in face shields or test tubes/test tube caps).

### IV. Methods of Preparing Filter Media

In general, fiber webs can be produced using suitable processes, such as using a wet-laid or a dry-laid process. Typically, a wet-laid process involves mixing together of the fibers; for example, cellulose fibers (e.g., virgin cellulose fibers obtained from hardwood and/or softwood pulp) can be mixed together with the fibrillated fibers (e.g., fibrillated polyolefin fibers and/or lyocell), to provide a fiber slurry. In some cases, the slurry is an aqueous-based slurry. In some embodiments, the cellulose fibers, fibrillated cellulose fibers, and fibrillated synthetic fibers are stored separately in various holding tanks prior to being mixed together. These fibers can be processed through a pulper or mixed (e.g., using a propeller) to break up any clumps before being mixed together.

In some embodiments, the wet-laid process uses similar equipment as a conventional papermaking process, which includes a hydropulper, a former or a headbox, a dryer, and an optional converter. For example, the slurry can be prepared in one or more pulpers. After mixing the slurry in a pulper, the slurry can be pumped into a headbox, where the slurry can optionally be combined with other slurries or additives. The slurry can also be diluted with additional water such that the final concentration of fiber is in a suitable range, such as for example, about 5% by weight fiber concentration/consistency or below (e.g., about 1% by weight fiber concentration/consistency or below). Fibers can then be collected on a screen or wire at an appropriate rate using any suitable machine, e.g., a fourdrinier, a rotoformer, a cylinder, or an inclined wire fourdrinier.

In some embodiments, the process further involves introducing binder (and/or other components) into a pre-formed fiber layer. In some embodiments, as the fiber layer is passed along an appropriate screen or wire, different components included in the binder, which can be in the form of separate emulsions, are added to the fiber layer using a suitable technique. In some embodiments, the components included in the binder can be pulled through the fiber layer using, for example, gravity and/or vacuum. In some embodiments, one or more of the components included in the binder resin can be diluted with softened water and pumped into the fiber layer. In some embodiments, a binder can be introduced to the fiber layer by spraying onto the formed media, or by any other suitable method, such as for example, size press application, foam saturation, curtain coating, dipping into a binder bath, rod coating, amongst others. In some embodiments, a binder material can be applied to a fiber slurry prior to introducing the slurry into a headbox. For example, the binder material can be injected into the fiber slurry and precipitated on to the fibers.

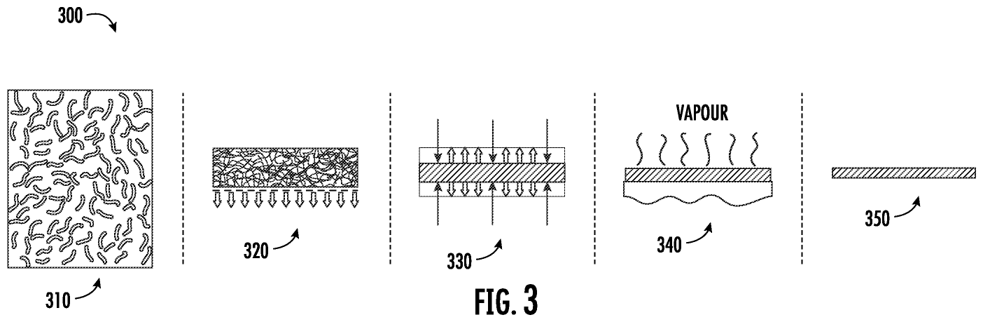

FIG. 3 shows typical papermaking process 300 that can be used to form sheet 350 comprising a non-woven web of cellulose fibers. Process 300 be can be adapted for use in preparing the media of the presently disclosed subject matter. As shown in FIG. 3, in step 310, cellulose fibers are first dispersed in a slurry (e.g., an aqueous slurry) and, in step 320 poured or pumped over a mesh screen (e.g., an 80 mesh, 100 mesh, or 150 mesh screen). Thus, in step 320, a web of fibers is formed on top of the mesh screen while excess liquid can drain through the mesh screen. A higher mesh screen can be selected if an undesirably high level of fines is found in the drain water, to improve fiber retention. In some embodiments, a 150 mesh screen can be used to provide good retention without slowing the drainage rate. If desired, as shown in step 330 of FIG. 3, the web can be pressed. Then, as shown in step 340, the web can be dried to remove residual water to provide sheet 350. According to some embodiments of the presently disclosed subject matter, step 340 can involve low temperature, non-contact drying, which can melt the polyolefin fibers and subsequent drying can be carried out to evaporate remaining water.

In some embodiments, the presently disclosed subject matter provides a method of preparing a filter media from a mixture of (a) chopped cellulosic pulp fibers, such as non-fibrillated cellulose fibers or a mixture of fibrillated and non-fibrillated cellulose fibers, and (b) dispersible thermoplastic fibers, such as, but not limited to fibrillated polyethylene fibers, using a wet-laid process. Because of the lower softening temperature of the thermoplastic fibers compared to the temperature used to dry the cellulose fiber-based web, the wet-laid process can provide for the thermoplastic fibers to be bonded first, followed by drying of the cellulosic fibers. Bonding of the thermoplastic fibers can be done using non-contact drying. In some embodiments, the non-contact drying is through air. After bonding of the thermoplastic fibers, the cellulosic fibers can be dried in a conventional or a non-contact drying step to generate hydrogen bonding. Optionally, the resulting wet-laid mat can then be impregnated with a binder/sizing agent, such as biodegradable polymers with or without a quantity of dispersed particles providing ESD characteristics. IN some embodiments, the mat is impregnated with starch nanoparticles. For example, in some embodiments, the wet-laid mat can be dipped in a bath comprising a binder/sizing agent, such as starch nanoparticles. In some embodiments, the excess bath liquid can be removed, e.g., via pressing or squeezing. In some embodiments, the sized mat can be further dried via a lightly calendaring process to maintain a porous structure. In some embodiments, once calendaring is completed, the substrate is then passed through a strong electric field between two metallic electrodes, causing polarization, injection of charge carriers, or both. Electrets can also be formed by carrier injection or corona discharge.

Thus, in some embodiments, the presently disclosed subject matter provides a method of preparing a biodegradable filter media, the method comprising: (i) providing a fiber mixture or dispersion (e.g., an aqueous fiber mixture), wherein the fiber mixture or dispersion comprises cellulose fibers and fibrillated thermoplastic fibers; (ii) forming a nonwoven mat from the fiber mixture (e.g., the aqueous fiber mixture); and (iii) drying the non-woven mat, thereby providing the biodegradable filter media. In some embodiments, the fiber mixture or dispersion comprises a cationic polymer (e.g., polyacrylamide). In some embodiments, step (ii) comprises pouring or pumping the fiber mixture over a mesh screen (e.g., an 80 mesh, 100 mesh, or 150 mesh screen). In some embodiments, step (iii) comprises removing excess water under vacuum and drying the non-woven mat in an oven. In some embodiments, the oven is at a temperature of about 40° C. to about 160° C. (e.g., about 100° C. to about 150° C.). In some embodiments, after (ii), a binder or sizing agent (e.g., starch nanoparticles) is applied to the non-woven mat. In some embodiments, the method further comprises preparing an electret from the nonwoven fiber, e.g., by passing the nonwoven mat through an electric field; injecting charge carriers; and/or by corona discharge.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

### Cellulose Fibers

The moisture content of hardwood and softwood pulps were determined by drying the material in an oven at 106° C. for 40 minutes and comparing the weight before and after drying. The softwood and hardwood materials had moisture contents of 7.02 and 9.2%, respectively, as received.

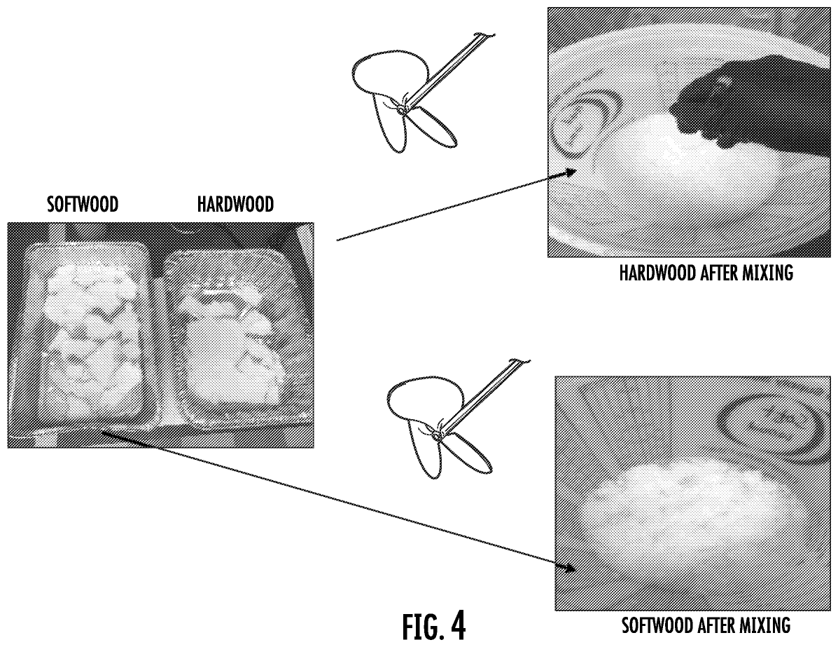

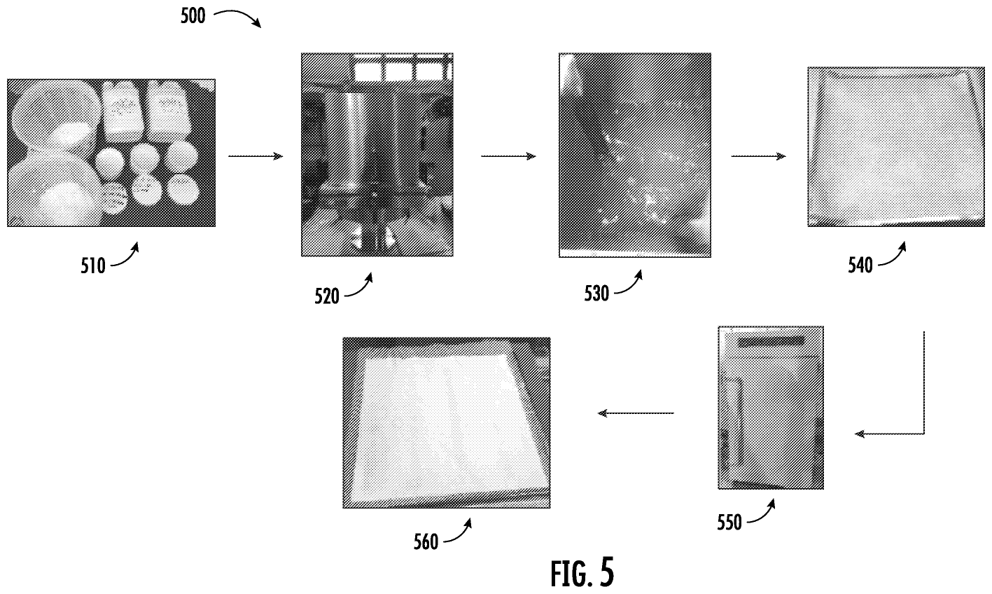

As shown in FIG. 4, softwood and hardwood pulp were soaked in deionized (DI) water with 4% concentration of the pulp. A propeller miser was used to breakdown the cellulose lumps to provide a mixed solution.

### Example 2

### Fibrillated Fibers

The moisture content of fibrillated fibers (EST8 fibrillated thermoplastic fibers from Mitsui Chemicals, Inc. (Tokyo, Japan) or 80-SR-20-30 fibrillated lyocell fibers from Lenzing AG (Lenzing, Austria)) were determined by drying the materials in an oven at 106° C. and comparing the weight before and after drying. Results are shown in Table 1, below. Moisture content was as received.

TABLE 1
Moisture content of Fibrillated Materials

| | | Moisture Content | |
|---|---|---|---|
| Material | Drying Time | (%) | Soak Time |
| EST8 | 95 min | 14.11 | 19 hours |
| 80-SR-20-30 | 135 min | 70.97 | 18 hours |
| EST8 (new) | 165 min | 55.0 | 24 hours |

In addition, both materials were soaked in DI water at 2% concentration of fiber and mixed with a high shear mixer to break up lumps. For the EST8, the mixing parameters were a speed of 3350 rpm for 10 minutes and for 80-SR-20-30, 1000 rpm for 3 minutes. Samples were removed for differential scanning calorimetry (DSC) to determine melting temperature. For EST8, the melting temperature was 79.55° C. For 80-SR-20-30, the melting temperature was 84.69° C.

### Example 3

### Retention Checking Procedures

Fibers were presoaked overnight. The next morning fibers were torn by hand into small pieces to avoid cutting fibers. The presoaked pulp is prepared to about 4% consistency and dispersed using a lab mixer impeller. For a target basis weight of 100 gsm, handsheets contain 30 grams softwood (SW), 68 grams hardwood (HW), 2 grams lyocell (80-SR-20-30). To the fibers was added between 1.0-1.5 grams equivalent as of a high molecular weight polyacrylamide (sold under the tradename PERFORM™PC8134F (Solenis, Wilmington, Delaware, United States of America) for every 2000 grams of fiber as an about 1% polymer solution (or for 100:1 diluted polymer, 100-150 grams of diluted polymer was added per 2000 grams total fiber).

For a filter media using fibrillated fibers, SW and HW pulps and fibrillated lyocell fibers were blended and mixed in water at a consistency of ≤1.0% consistency. To this mixture was added diluted polyacrylamide (sold under the tradename PERFORM™PC8134F) (1%). This slurry was mixed for 5 minutes and then used to make handsheets. If using fibrillated polyolefin fibers, the same procedure was followed. In using fibrillated polyolefin fibers, about 5-10% of the fiber content was the fibrillated polyolefin fibers, with the SW and/or HW percentages being reduced. A sample of pulp from the mixing chest when squeezed should have clear water if sufficient cationic polymer retention aid is added. Additionally, a sample of filtrate from a handsheet mold drain line should have no fines if sufficient cationic polymer retention aid is added.

### Example 4

### General Procedure for Making Non-Woven Web

Six test formulations were prepared as described in Table 2, below, and used to prepare a non-woven web using wet-laid process 500 as shown in a series of photographic images in FIG. 5. Briefly, the raw materials shown in image 510 were introduced into a wet-laid tank shown in image 520 and were dispersed using chaotic advection for 5 minutes, as shown in image 530. A mat was formed using an 80 mesh screen. Excess water was removed from the mat using vacuum, as shown in image 540. The mat was dried in an oven for 10 minutes at 133° C. as shown in image 550. The dried cellulose mat is shown in image 560. For comparison, a control sample was prepared containing 30% softwood (SW), 70% hardwood (HW) and 0.75 grams of high molecular weight cationic polyacrylamide to aid in retention of the fibrillated fibers.

Samples 1 and 2 were prepared to test the effects of fibrillated synthetic polymer fiber content on electret and filtration efficiency. Sample 3 was prepared to test changes in pleatability when the SW of Sample 2 is replaced with lyocell. Sample 4 was prepared to test the effects on strength, pleat-ability, and efficiency when some of the SW of Sample 2 is replaced with fibrillated lyocell. Samples 5 and 6 were prepared to test the effects on electret and filtration efficiency when a binder comprising starch nanoparticles is added. The starch nanoparticle binder can be added after formation of the filter mat, e.g., by using a “dip and squeeze” method, e.g., dipping the mat into a bath comprising the binder (e.g., a bath comprising a dilution of solid binder, e.g., comprising about 20%-40% solids) and squeezing the mat to remove any excess.

TABLE 2
Exemplary Fiber Media Compositions

| | | Sam- | Sam- | Sam- | Sam- | Sam- | Sam- |
|---|---|---|---|---|---|---|---|
| | | ple 1 | ple 2 | ple 3 | ple 4 | ple 5 | ple 6 |
| HW (%) | | 65 | 55 | 55 | 55 | 55 | 55 |
| SW (%) | | 30 | 30 | 0 | 25 | 30 | 30 |
| Lyocell¹ | A | 0 | 0 | 0 | 5 | 0 | 0 |
| (%) | B | 0 | 0 | 30 | 0 | 0 | 0 |
| fibrillated | | 5 | 15 | 15 | 15 | 15 | 15 |
| polyolefin² | | | | | | | |
| (%) | | | | | | | |
| Binder³ | A | 0 | 0 | 0 | 0 | 25 | |
| (%) | B | 0 | 0 | 0 | 0 | | 25 |

| | | | | | | |
|---|---|---|---|---|---|---|
| Target basis weight | 100 | 100 | 100 | 100 | 125 | 125 |
| (gsm) | | | | | | |

¹Lyocell A is 80SR, Fibrillated 1.7 dtex; Lyocell B is 6 mm, 1.7 dtex; both from Lenzing AG (Lenzing, Austria)
²fibrillated polyolefin sold under the tradename FYBREL ™ (Mitsui Chemicals, Inc.; Tokyo, Japan), EST8, 5 μm diameter
³Binder A is a binder sold under the tradename ECOSPHERE ™ 2330 BIOLATEX ™ Binder; Binder B is a binder sold under the tradename ECOSPHERE ™ 2108 BIOLATEX ™ Binder, both from EcoSynthetix, Ltd., Burlington, Canada. Binder % is provided as a wt % in comparison to the total weight of the filter media.

### Example 5

### Particle Removal Efficiency

Single layer and multilayer filtration media described above were tested to determine the “Most Penetrating Particle Size” (MPPS). MPPS was measured using standard testing methods as described in European Standard EN 1822-3 for high efficiency media. Briefly, an aerosol of 2% polydisperse NaCl was used for testing. The specific range of sizes measured 20 nm to 500 nm. Efficiency data was gathered and plotted with various particle sizes and efficiencies and the point at which minimum efficiency is detected for the particle size is determined. The media is qualified for that particular particle size.

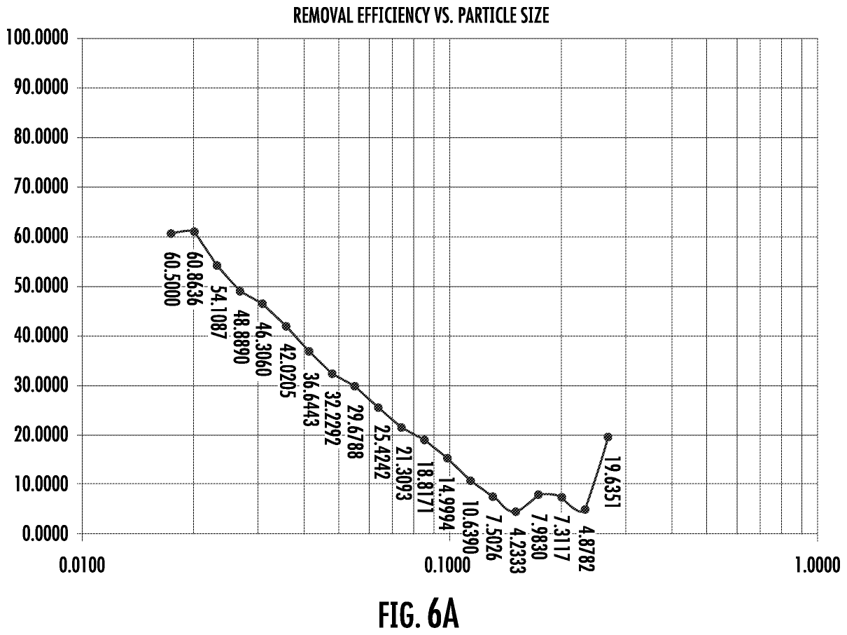

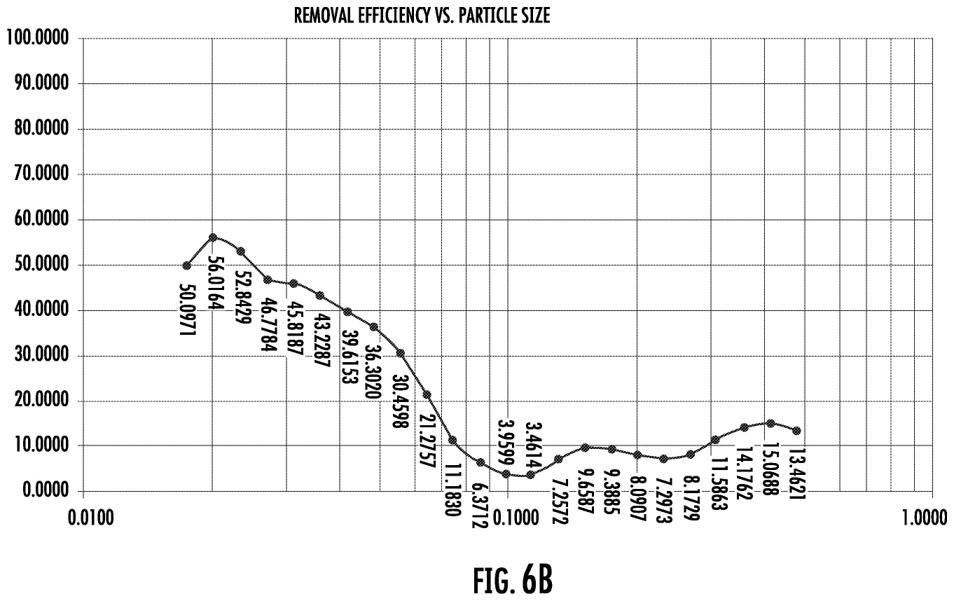

Table 3 shows the results of particle removal efficiency for exemplary single and multilayer fiber media. Results indicate that removal efficiency of a 0.075 μm particle is relatively low when compared to a filter media comprising meltblown (e.g., thermoplastic) fibers typically used in facemask and other high efficiency, smaller particle filtration applications. See also FIGS. 6A and 6B. “Add-on” refers to starch nanoparticle binder added as a saturant via the “dip and squeeze” method described in Example 4, targeting a final basis weight of 140 gsm, where the fiber content accounts for 100 gsm.

TABLE 3
Most Penetrating Particle Removal Efficiency
of Various Samples. Various Samples Tested

| Sample | | # of | Efficiency |
|---|---|---|---|
| ID | Construction | Layers | (%) |
| 3 | 55% HW + 30% Lyocell + 15% | 1 | 6.8 |
| | Fybrel ™ | | |
| 3A | 55% HW + 30% Lyocell + 15% | 4 | 14.5 |
| | Fybrel ™ | | |
| 6.1 | [45% HW + 30% 6 mm Lyocell + | 1 | 4.4 |
| | 25% Fybrel ™] 40% Add-on E2330 | | |
| 6.1A | [45% HW + 30% 6 mm Lyocell + | 2 | 13.3 |
| | 25% Fybrel ™] 40% Add-on E2330 | | |
| 6.1B | [45% HW + 30% 6 mm Lyocell + | 4 | 17.7 |
| | 25% Fybrel ™_] 40% Add-on | | |
| | E2330 | | |
| | Meltblown | 1 | 77.09 |
| | Meltblown | 4 | 98.76 |

### Example 6

### Filtration Efficiency

To understand how filtration efficiency varies with various particle sizes, media can be tested for ‘Minimum Efficiency Reporting Value’, commonly known as MERV. MERV is a measurement scale designed in 1987 by the American Society of Heating, Refrigerating and Air-Conditioning Engineers (ASHRAE) to report the effectiveness of air filters in more detail than other ratings. Higher ratings remove a larger percentage and broader range of debris from the air. See Table 4, below, which shows MERV rating performance characteristics.

TABLE 4
MERV Rating Performance Characteristics.

| | Dust Spot | Ability to Remove | Dust Particle Size |
|---|---|---|---|
| MERV Rating | Efficiency | Dust | (μm) |
| MERV 1-4 | Less than 20% | 60%-80% | ≥10 |
| MERV 5-8 | 20%-60% | 80%-95% | 3-10 |
| MERV 9-12 | 40%-85% | 90%-98% | 1-3 |
| MERV 13-16 | 70%-98% | 95%-99% | 0.3-1 |
| MERV 17-20 | More than 98% | 99% or more | 0.3 |

More generally, there are typically considered to be four levels of air filters. The entry-level filter is a MERV 6 filter. This is filter that can trap basic household dust and pollen. A MERV 8 filter traps pollen and dust, and also dust mites and mold spores. A MERV 11 filter traps all that the MERV 8 filter traps along with pet dander, smoke, smog, and air borne particles from coughs and sneezes. A MERV 13 filter can further trap microscopic viruses and bacteria. Accordingly, MERV 11 and 13 filters are particularly useful for households with pets, children, infants, the elderly, allergy sufferers, and those with other respiratory issues, such as asthma.

TABLE 5
Exemplary Air Filter Performance and Construction.

| | | | Typical | |
|---|---|---|---|---|
| Standard | | | Controlled | |
| MERV | Dost Spot | | Contaminant/ | |
| Rating | Efficiency | Arrestance | applications | Typical Air Filter/Cleaner Type |
| 13 | 70-75% | >95% | Legionella/ | Pleated Filters: Disposable, |
| | | | residential | extended surface area, thick |
| 11 | 60-65% | >95% | Humidifier dust, | with cotton-polyester blend |
| | | | Lead dust/ | media, cardboard frame |
| | | | residential and | Box Filter: Rigid style |
| | | | commercial | cartridge filters, 6 to 12 |
| | | | | inches deep, can include |
| | | | | lofted or paper media |
| 8 | 30-35% | >90% | Mold spores/ | Pleated filters: Disposable, |
| | | | Residential and | extended surface area, thick |
| | | | commerical | with cotton-polyester blend |
| 6 | <20% | 85-90% | Fabric protector, | media, cardboard frame |
| | | | Dusting aids/ | Cartridge Filters: Graded |
| | | | residential and | density viscous coated cube or |
| | | | industrial | pocket filters, synthetic media |

To estimate the MERV ratings of the presently disclosed filter media, the filter performance of select media on each of 12 particles sizes, during six test cycles (a total of 72 values or calculated values) was determined according using the Vertical Test Duct KCl efficiency testing method based on the ASHRAE 52.2 standard (e.g., 18.6° C.-26.4° C., 42.5% relative humidity to 49.8% relative humidity, and about 100 kPa pressure). For each value or calculated value, the filtration efficiency is stated as a ratio of the downstream-to-upstream particle count. The lowest values over the six test cycles are then used to determine the Composite Minimum Efficiency Curve. Using the lowest measured efficiency avoids the misinterpretation of averaging and provides a “worst case” experience over the entire test.

The twelve size ranges are placed in three larger groups according to the following: ranges 1-4 (or E1), which is 0.3 to 1.0 μm; ranges 5-8 (or E2), which is 1.0 to 3.0 μm; ranges 9-12 (or E3), which is 3.0 to 10.0 μm. Averaging the Composite Minimum Efficiency for each of these groups determines the average Particle Size Efficiency (PSE), and the resulting three percentages (E1, E2, and E3) are used to determine the MERV from Table 3 of the ASHRAE 52.2 standard. For media to be MERV 8 or higher, E2 should be ≥20 and E3≥70. For media to be MERV 11 or higher, E1 should be ≥20; E2≥65, and E3≥85.

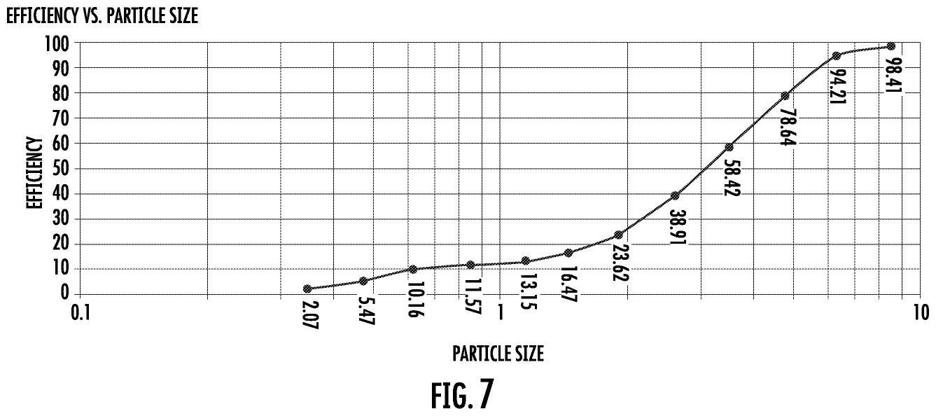

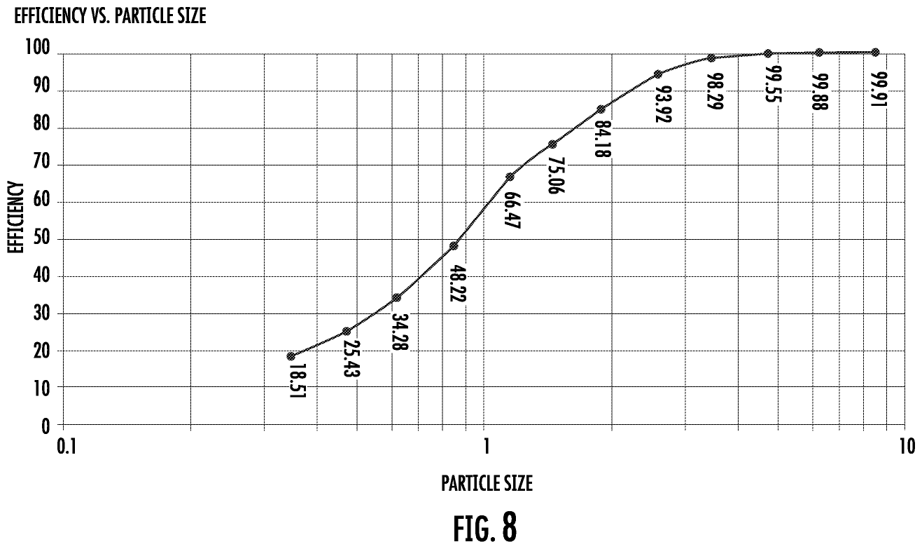

FIG. 7 along with Table 6, below, details characterization of the media for filtration efficiency, % capturing particle sizes. Analysis of the test data indicates that the media with such filtration efficiency will fall in a MERV 8 rating as indicated below, Table 6.

TABLE 6
Particle Size versus Efficiency of cellulose
media formed with 4 layers of 3A.

| | Mean | | | |
|---|---|---|---|---|
| Particle Size | Particle Size | Average | | Average |
| (μm) Range | (μm) | Efficiency (%) | Group | Efficiency (%) |
| 0.30-0.40 | 0.346 | 2.07 | E1 | 7 |
| 0.40-0.55 | 0.469 | 5.467 | | |
| 0.55-0.70 | 0.620 | 10.16 | | |
| 0.70-1.00 | 0.837 | 11.57 | | |
| 1.00-1.30 | 1.140 | 13.15 | E2 | 23 |
| 1.30-1.60 | 1.442 | 16.47 | | |
| 1.60-2.20 | 1.876 | 23.62 | | |
| 2.20-3.00 | 2.569 | 38.91 | | |
| 3.00-4.00 | 3.464 | 58.42 | E3 | 82 |
| 4.00-5.50 | 4.690 | 78.64 | | |
| 5.50-7.00 | 6.205 | 94.21 | | |
| 7.00-10.0 | 8.367 | 98.41 | | |

Estimated MERV 8

With a MERV rating of 8, the 4-layer construction is suitable for applications, such as use as a pre-filter media upstream of a meltblown media for high efficiency applications.

### Example 7

Filter Media with Refined Pulp

Without being bound to any one theory, it is believed that refining the cellulose fiber component of the presently disclosed filter media can assist in reducing pore sizes and can thereby increase efficiency as well as MERV rating. In addition, electret treatment of synthetic components enhances filtration efficiency. In support of the use of refined fiber to enhance efficiency, the present studies shown that whereas mats described in the examples above prepared with unrefined pulp can have a MERV 8 rating, samples prepared with refined pulp show a MERV 11 rating.

More particularly, refining pulps, e.g., refining hardwood and/or softwood pulps, with decreased freeness can reduce pore size, which is believed to be helpful for filtration efficiency. Table 7, below, shows furnish details of samples tested. Samples ending with “R” indicated refined pulp. Freeness of pulp used in samples 3A and 6.1A: 465 CSF (HW). Freeness of pulp used in samples 3R and 6.1R: 315 CSF (SW), 285 CSF (HW).

TABLE 7
Furnish details for samples in this Example.

| | | | | | | Saturant | |
|---|---|---|---|---|---|---|---|
| | | | Lyocell Fiber (%) | | | and % add-on | |
| | | | 6 mm | 4 mm | | ECOSPHERE ™ | Final |
| | | | 1.7 dtex | 1.7 dtex | EST8 | 2330 | Basis |
| Sample | Cellulose Pulp (%) | | (Lyocell | (Lyocell | 5 μm | BIOLATEX ™ | Weight |
| ID | SW | HW | fibers) | fibers) | diameter | Binder | (gsm) |
| 3A | — | 55 | 30 | — | 15 | — | 100 |
| 6.1A | — | 45 | 30 | — | 25 | 40 | 125 |
| 3R | 30 | 55 | — | — | 15 | — | 100 |
| 6.1R | 30 | 45 | — | — | 25 | 40 | 125 |
| Lyo4 | — | — | — | 100 | — | — | 300 |
| Lyo6 | — | — | 100 | — | — | — | 300 |

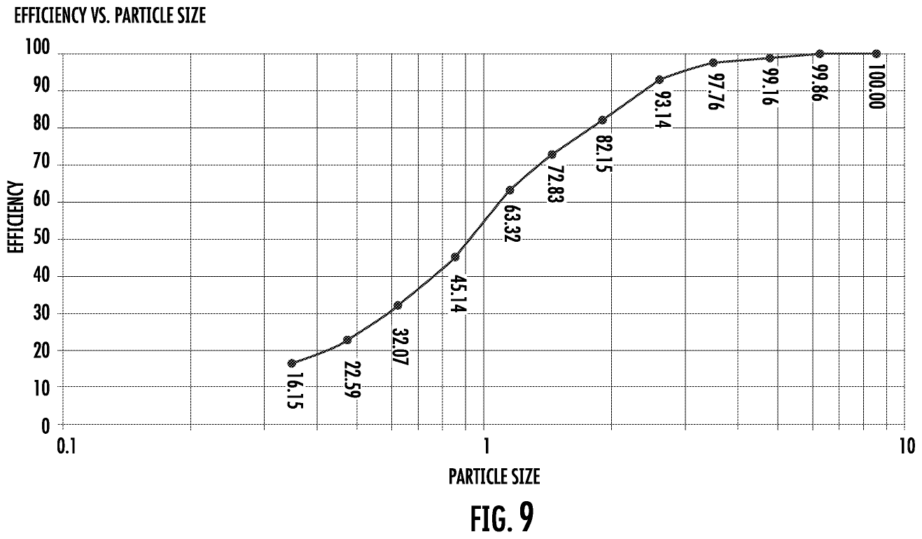

Test results of samples 3R and 6.1R indicated that a MERV 11 rating can be achieved when sheets are made with a percentage of fibers highly refined. Tables 8 and 9, below indicate results of filtration efficiency testing and compilation of data. See also, FIGS. 8 and 9.

TABLE 8
Test results of Sample 3R (4 layers).

| | Mean | | | |
|---|---|---|---|---|
| Particle Size | Particle Size | Average | | Average |
| (μm) Range | (μm) | Efficiency (%) | Group | Efficiency (%) |
| 0.30-0.40 | 0.346 | 16.15 | E1 | 29 |
| 0.40-0.55 | 0.469 | 22.59 | | |
| 0.55-0.70 | 0.620 | 32.07 | | |
| 0.70-1.00 | 0.837 | 45.14 | | |
| 1.00-1.30 | 1.140 | 63.32 | E2 | 78 |
| 1.30-1.60 | 1.442 | 72.83 | | |
| 1.60-2.20 | 1.876 | 82.15 | | |
| 2.20-3.00 | 2.569 | 93.14 | | |
| 3.00-4.00 | 3.464 | 97.76 | E3 | 99 |
| 4.00-5.50 | 4.690 | 99.16 | | |
| 5.50-7.00 | 6.205 | 99.86 | | |
| 7.00-10.0 | 8.367 | 100.00 | | |

Estimated MERV 11

TABLE 9
Test results of Sample 6.1R (4 layers).

| | Mean | | | |
|---|---|---|---|---|
| Particle Size | Particle Size | Average | | Average |
| (μm) Range | (μm) | Efficiency (%) | Group | Efficiency (%) |
| 0.30-0.40 | 0.346 | 18.51 | E1 | 32 |
| 0.40-0.55 | 0.469 | 25.43 | | |
| 0.55-0.70 | 0.620 | 34.28 | | |
| 0.70-1.00 | 0.837 | 48.22 | | |
| 1.00-1.30 | 1.140 | 66.47 | E2 | 80 |
| 1.30-1.60 | 1.442 | 75.06 | | |
| 1.60-2.20 | 1.876 | 84.18 | | |
| 2.20-3.00 | 2.569 | 93.92 | | |
| 3.00-4.00 | 3.464 | 98.29 | E3 | 99 |
| 4.00-5.50 | 4.690 | 99.55 | | |
| 5.50-7.00 | 6.205 | 99.88 | | |
| 7.00-10.0 | 8.367 | 99.91 | | |

Estimated MERV 11

It was also found that combination of a pre-filter layer made with long unrefined pulp having a MERV 8 rating and a filtration layer made with a high percentage of refined hardwood pulps with a MERV 11 rating can result in a MERV 12 rating. To achieve a MERV 13 rating, a greater percentage of efficiency layers, such as 3R or 6.1R can be used. Tables 10 and 11, below, provide details regarding the construction of a filter media to achieve various levels of efficiency and, thereby, MERV rating. ECOSH refers to the binder sold under the tradename EcoSphere™ 2330 Biolatex™ Binder.

TABLE 10
Details of fiber and saturant used in media development

| | Sample ID | | | |
|---|---|---|---|---|
| Furnish Details, % | | 3A | 3R | 6.1R |
| Softwood | Unrefined, 625 CSF | | | |
| | Refined, 315 CSF | | 30 | 30 |
| Hardwood | Unrefined, 465 CSF | 55 | | |
| | Refined, 285 CSF | | 55 | 45 |
| Lyocell 6 mm 1.7 dtex | | 30 | | |
| fiber | | | | |
| EST8 5 μm diameter | Fibrillated | 15 | 15 | 25 |
| ECOSH | Saturated, % add-on | 0 | 0 | 40 |

TABLE 11
Filtration Characterization.

| | 3A | 3R | 6.1R |
|---|---|---|---|
| E1 | 7 | 29 | 32 |
| E2 | 23 | 78 | 80 |
| E3 | 82 | 99 | 99 |
| MERV Rating | 8 | 11 | 11 |

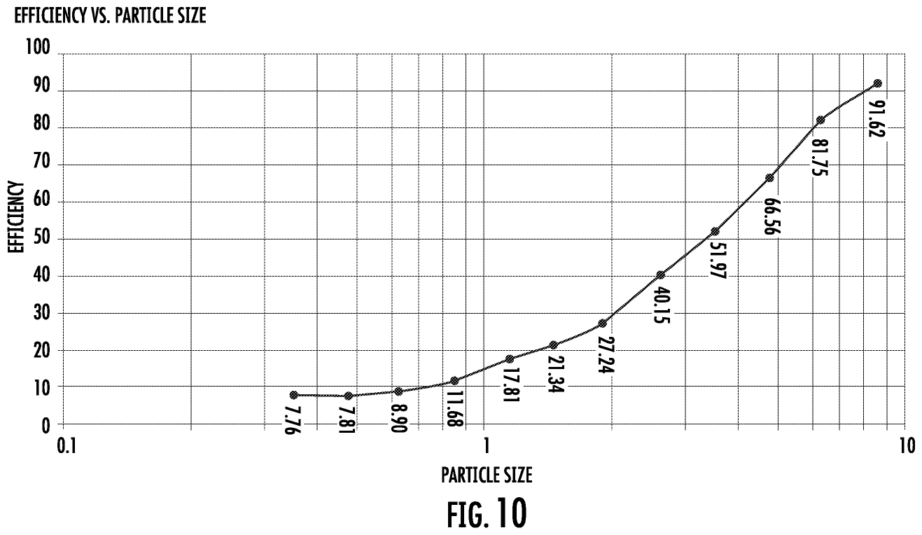

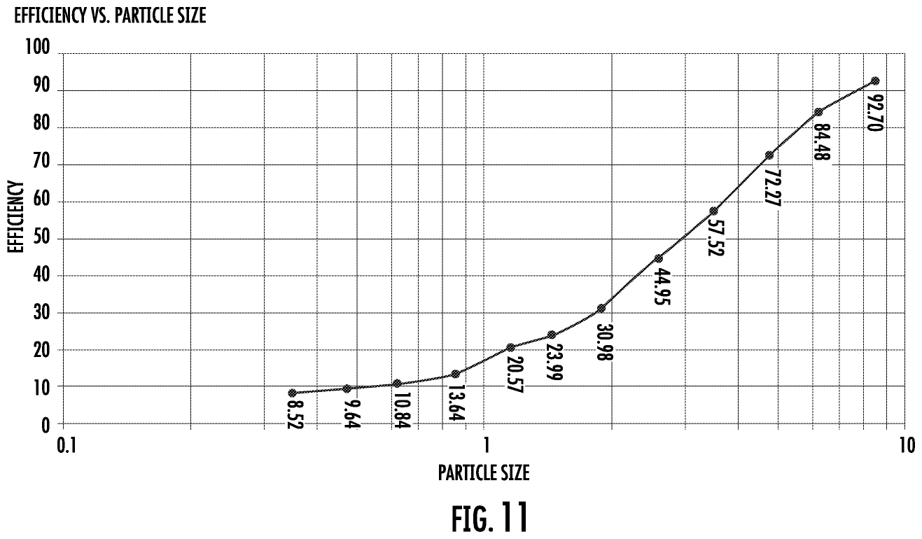

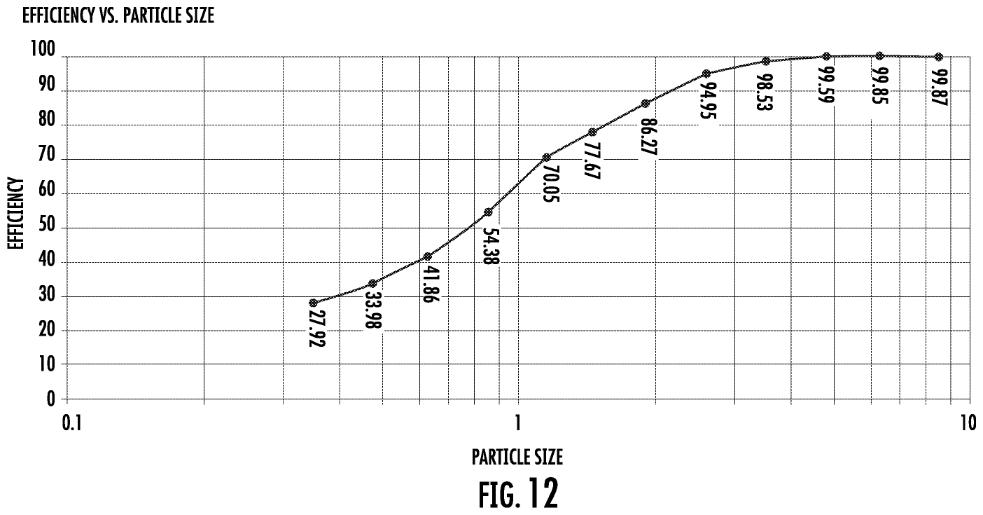

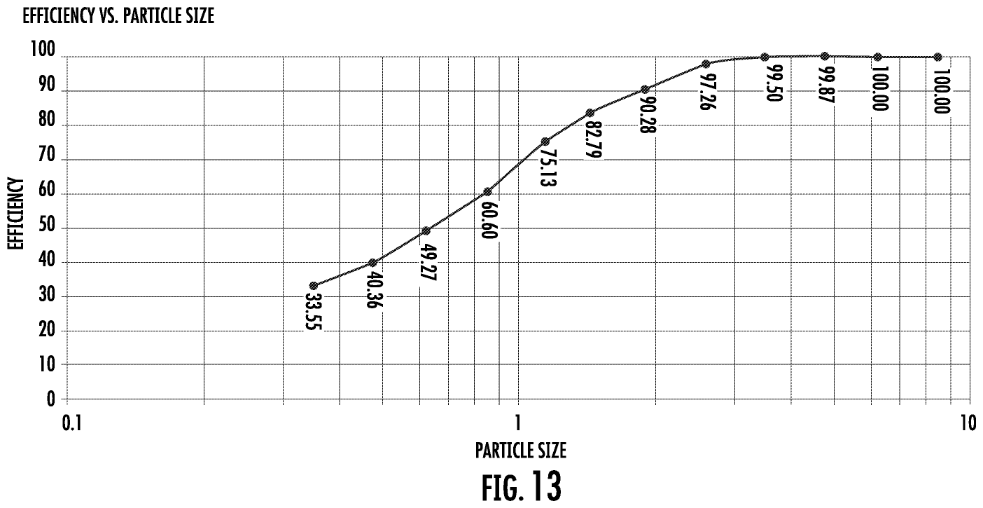

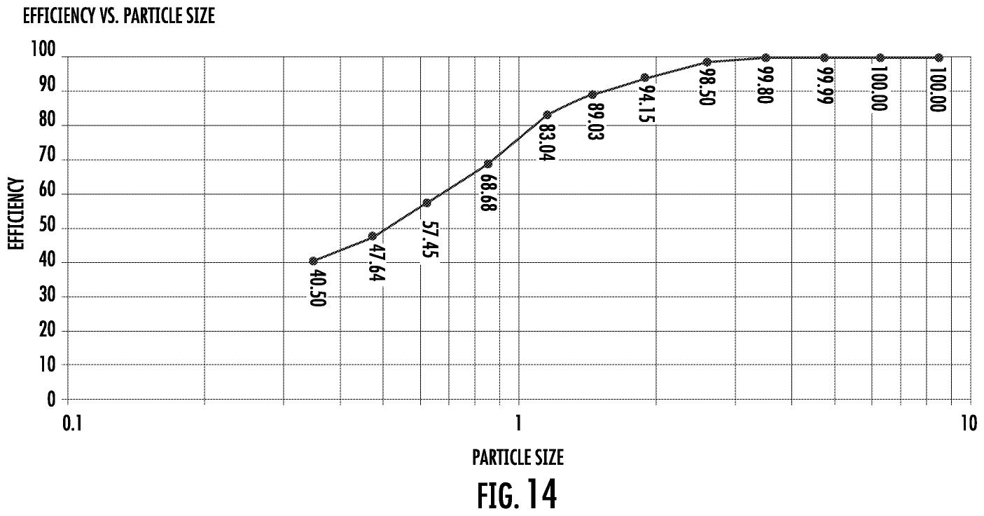

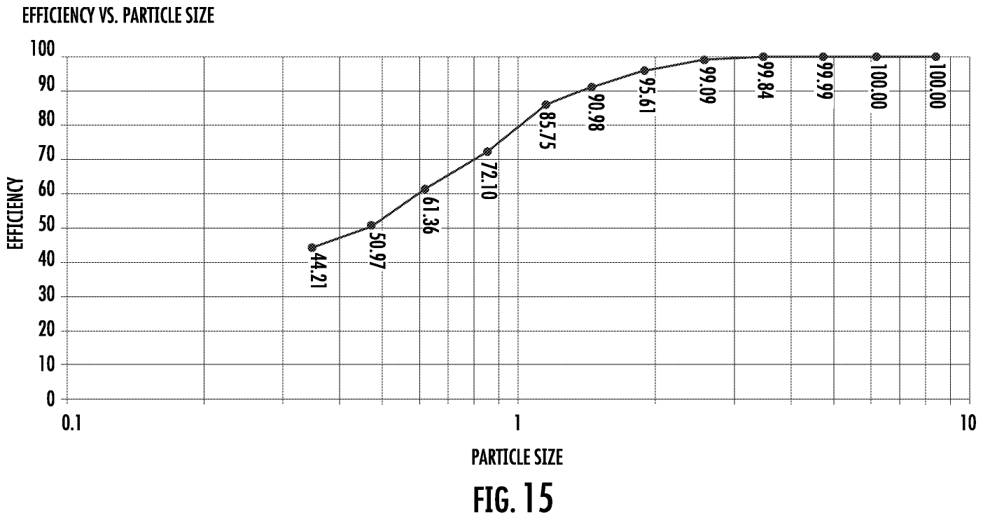

Filtration efficiency testing on 300 gsm samples, Ly04 and Ly06, made with 100% Lyocell un-fibrillated 4 and 6 mm fibers, respectively, indicate a MERV 8 rating. See FIGS. 10 and 11. Combining 1 layer of this acting as a pre-filter layer (non-primary) with layers of samples of 3R and 6.1 R (primary filtration layers) results in a MERV 12 or MERV 13 rating. See Table 12, below. See also FIGS. 12-15.

TABLE 12
Filtration Characterization.

| | | | | | Ly06 (1) + | Ly06 (1) + |
|---|---|---|---|---|---|---|
| | | | | Ly06 (1) + | 3R (1) + | 3R (2) + |
| | Ly04 | Ly06 | Ly06 (1) + | 6.1R (4) + | 6.1R (4) + | 6.1R (4) + |
| | (1) | (1) | 6.1R (4) | Ly06 (1) | Ly06 (1) | Ly06 (1) |
| E1 | 9 | 11 | 40 | 46 | 54 | 57 |
| E2 | 27 | 30 | 82 | 86 | 91 | 93 |
| E3 | 73 | 77 | 99 | 100 | 100 | 100 |
| MERV | 8 | 8 | 12 | 12 | 13 | 13 |
| Rating | | | | | | |

Numbers in parentheses indicate number of layers.

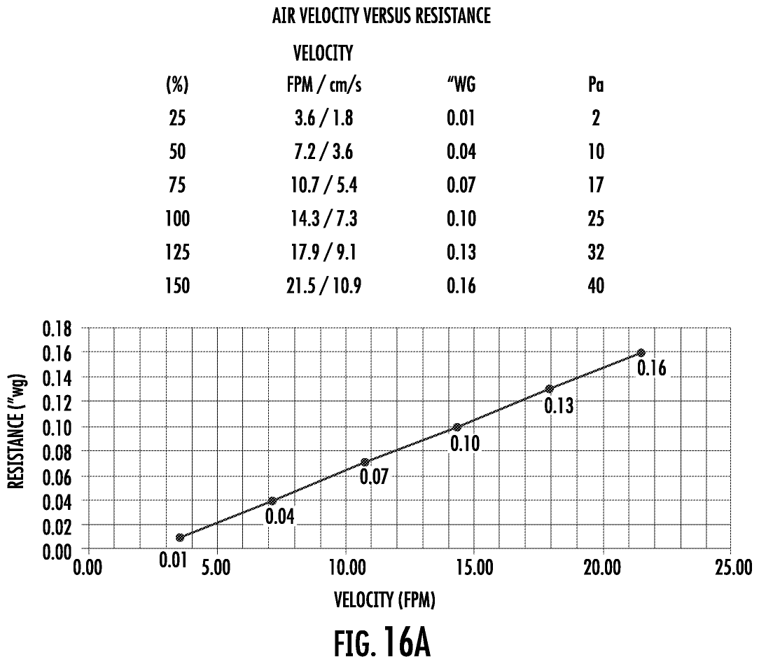

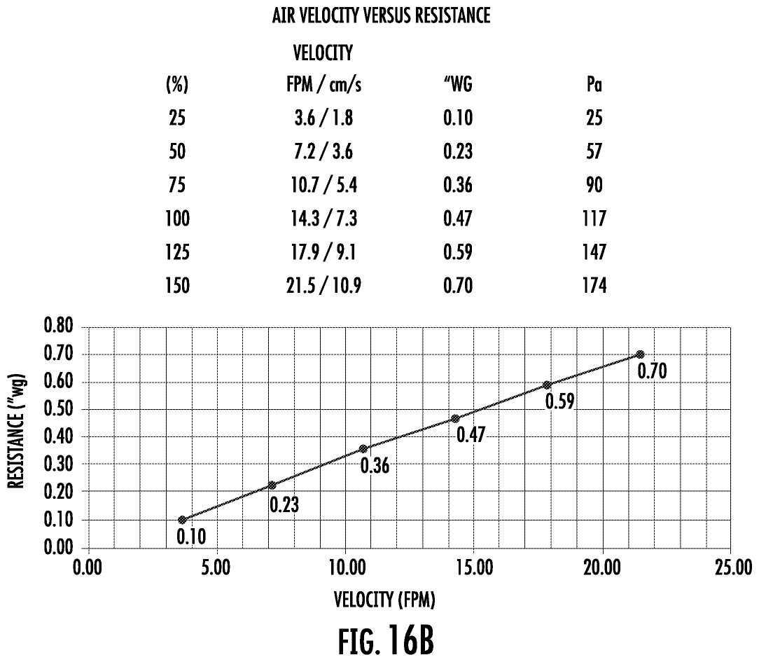

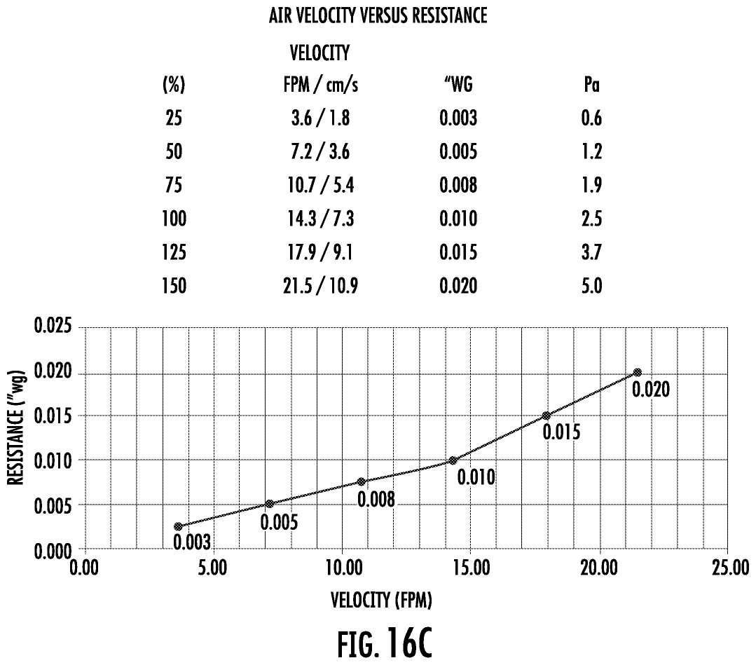

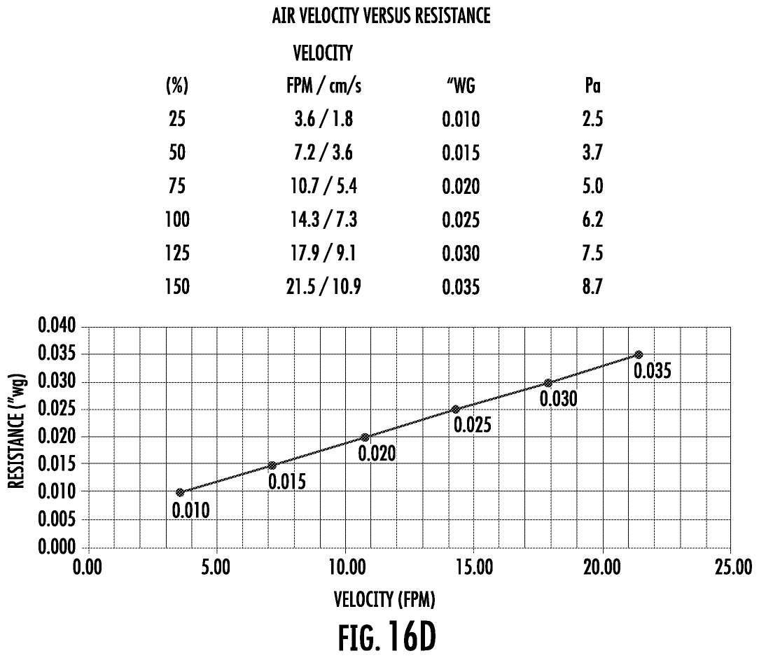

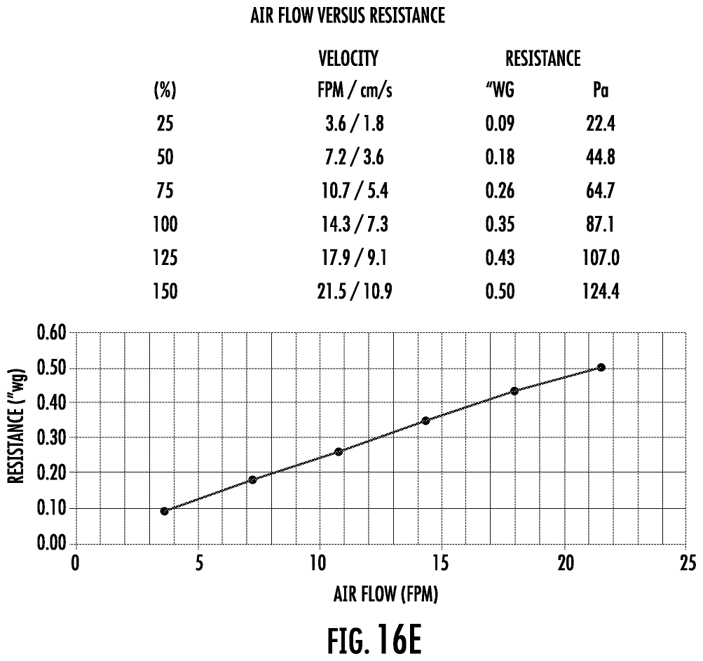

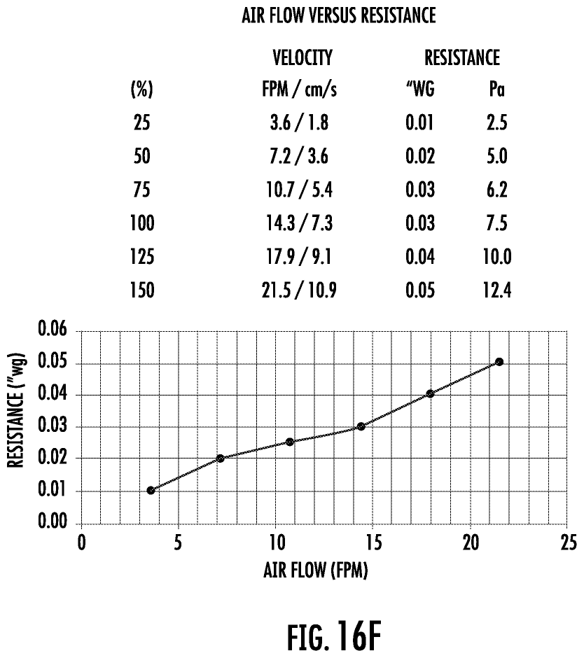

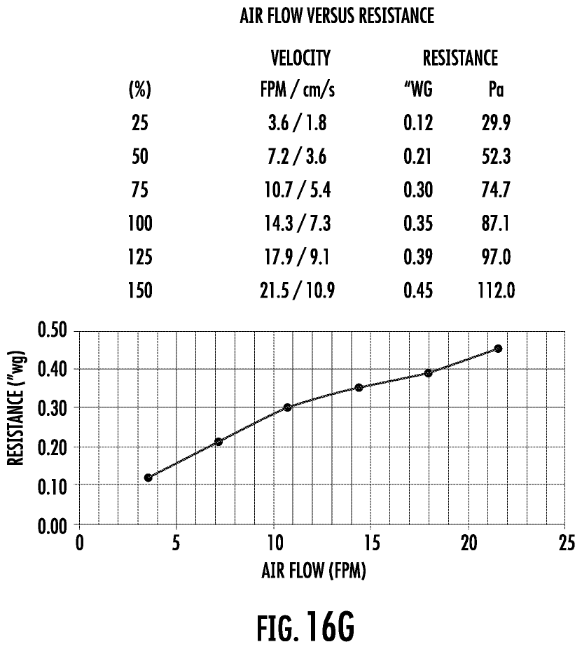

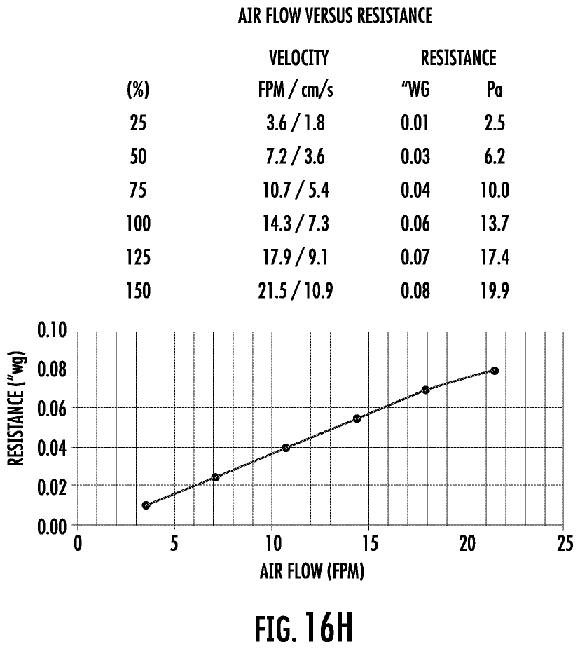

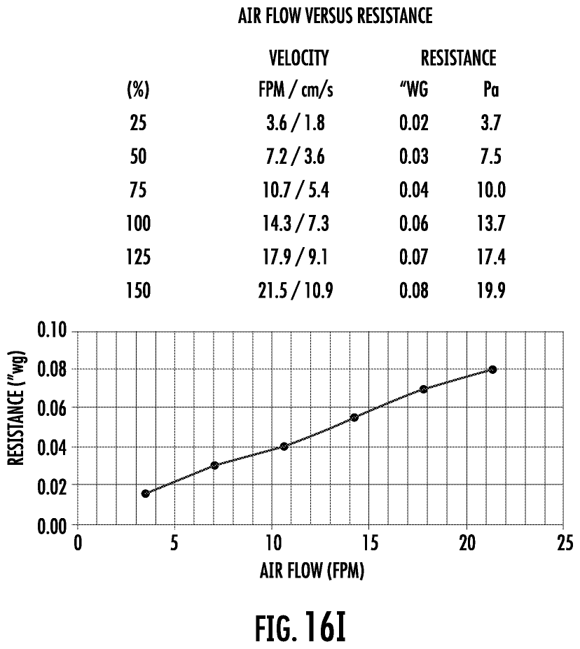

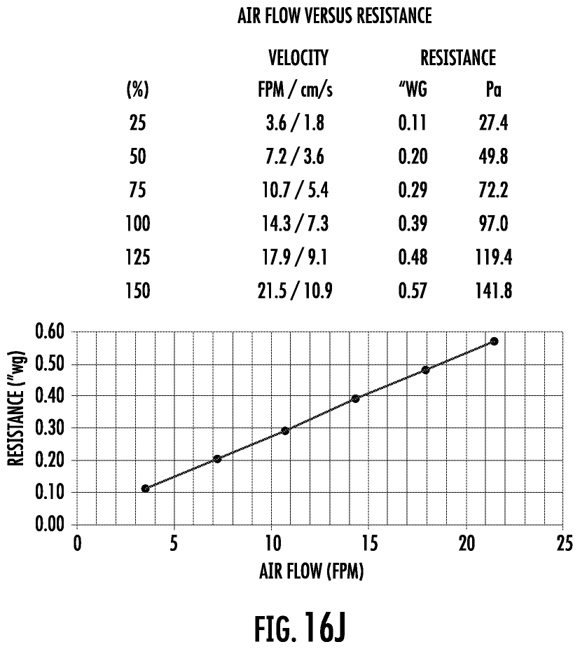

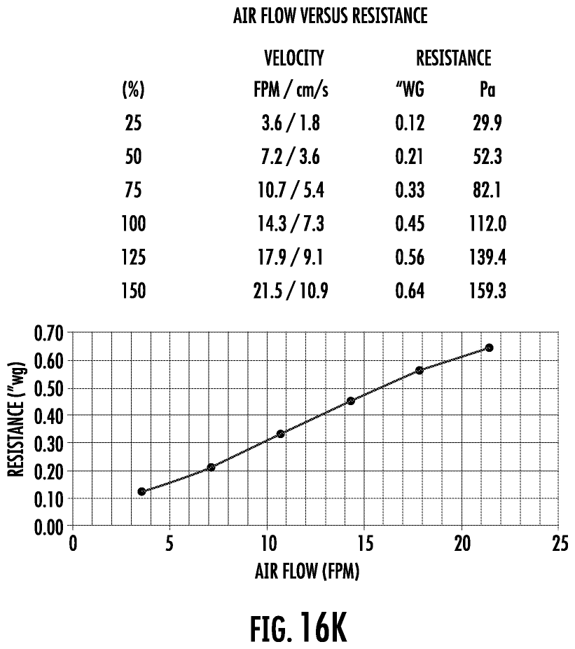

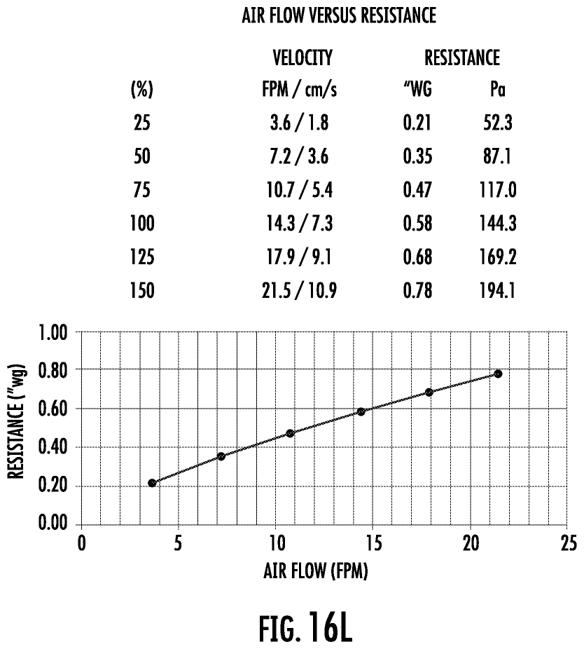

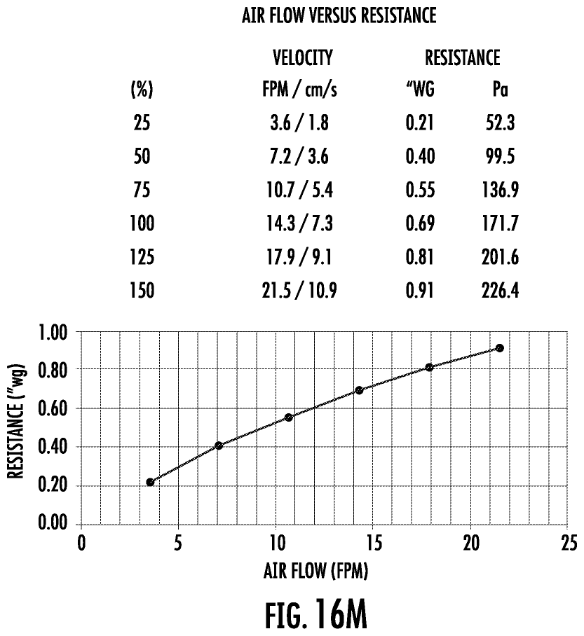

FIGS. 16A-16M show graphs of air flow versus resistance for mats and composites of the presently disclosed subject matter.

In summary, to achieve a MERV 13 rating, more than 4 layers of mats made with refined pulp or fibrillated fibers can be used as evidenced by the determination of filtration efficiency with a sandwich construction with >4 inner layers. These layers control increased efficiency of catching smaller particles.

### Example 8

### Biodegradation

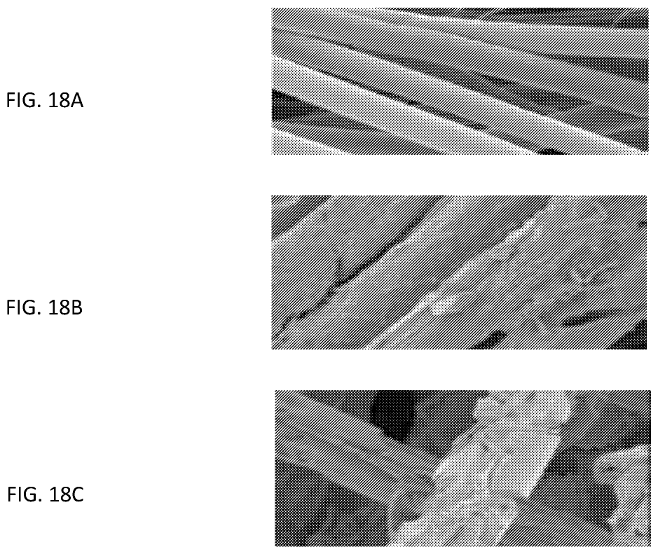

The presently disclosed media can break down into carbon dioxide and water under enzymatic action (e.g., after entering sewage or other waste streams). To illustrate this ability, a composite comprising three layers of a non-woven mat prepared from a fiber mixture comprising 45% HW, 30% 6 mm Lyocell and 25% FYBREL™ and further comprising 40% add-on E2330 was buried 6″ deep in moist soil. FIG. 18A shows a SEM image of the fibers prior to burial. FIGS. 18B and 18C show SEM images of the fibers after 4 days and 7 days of burial, respectively. Based on these images, it is predicted that the composite can completely biodegrade in about 6 to 8 weeks.

The embodiments disclosed herein are provided only by way of example and are not to be used in any way to limit the scope of the subject matter disclosed herein. As such, it will be understood that various details of the presently disclosed subject matter may be changed without departing from the scope of the presently disclosed subject matter. The foregoing description is for the purpose of illustration only, and not for the purpose of limitation.

What is claimed is:

1. A biodegradable filter media comprising cellulose fibers and fibrillated thermoplastic fibers.

2. The biodegradable filter media of claim 1, wherein the cellulose fibers comprise hardwood fibers, softwood fibers, fibrillated cellulose fibers, or any combination thereof.

3. The biodegradable filter media of claim 1 or claim 2, wherein the fibrillated thermoplastic fibers comprise fibrillated polyolefin fibers, optionally wherein the fibrillated polyolefin fibers comprise polyethylene fibers, polypropylene fibers, or a blend thereof.

4. The biodegradable filter media of any one of claims 1-3, wherein the filter media further comprises a cationic polymer.

5. The biodegradable filter media of claim 4, wherein the cationic polymer comprises polyacrylamide.

6. The biodegradable filter media of claim 4 or claim 5, wherein the biodegradable filter media comprises:
(a) about 40 weight percent (wt %) to about 70 wt % hardwood fibers, optionally about 55 wt % to about 70 wt % hardwood fibers, on the basis of total fiber weight in the media;
(b) about 0 wt % to about 30 wt % softwood fibers, optionally about 20 wt % to about 30 wt % softwood fibers, on the basis of total fiber weight in the media;
(c) about 0.5 wt % to about 15 wt % fibrillated thermoplastic fibers, optionally about 5 wt % to about 10 wt % fibrillated thermoplastic fibers, on the basis of total fiber weight in the media;
(d) about 0 wt % to about 30 wt % fibrillated cellulose fibers, optionally about 1 wt % to about 2 wt % fibrillated cellulose fibers, on the basis of total fiber weight in the media; and
(e) about 0.5 parts to about 1.5 parts of cationic polymer, optionally about 0.75 parts of cationic polymer, per every 100 parts of fiber.

7. The biodegradable filter media of claim 6, wherein the hardwood fibers and/or the softwood fibers comprise refined fibers.

8. The biodegradable filter media of any one of claims 1-7, wherein the biodegradable filter media further comprises a binder/sizing agent, optionally wherein the binder/sizing agent comprises bio-based, biodegradable polymeric particles and/or wherein the biodegradable filter media comprises between about 5 wt % and about 35 wt % of the binder/sizing agent, further optionally wherein the binder/sizing agent comprises starch nanoparticles.

9. The biodegradable filter media of any one of claims 1-8, wherein the fibrous web is in the form of a non-woven mat.

10. The biodegradable filter media of claim 9, wherein the non-woven mat is a wet-laid mat, optionally wherein the thermoplastic fibers have a lower softening temperature than a temperature used to dry cellulose fibers in the mat.

11. The biodegradable filter media of claim 9 or claim 10, wherein the non-woven mat is an electret, optionally, wherein the electret is prepared by passing the non-woven mat through an electric field between two metallic electrodes, via injection of charge carriers, corona discharge, or a combination thereof.

12. A multilayer filter media comprising a plurality of layers, wherein each of said layers comprises a porous substrate and wherein at least one of said layers comprises a biodegradable filter media of one of claims 1-11.

13. The multilayer filter media comprising a plurality of layers, wherein at least two of said plurality of layers comprises a biodegradable filter media of one of claims 1-11.

14. The multilayer filter media of claim 13, wherein the plurality of layers comprises, from top to bottom:
(i) a first outer non-woven mat comprising or consisting of fibrillated cellulose fibers, optionally consisting of 100 wt % fibrillated cellulose fibers;
(ii) at least four interior non-woven mats, wherein each of the at least four interior non-woven mats is the same or different and comprises about 40 wt % to about 70 wt % refined hardwood fibers, about 0 wt % to about 30 wt % refined softwood fibers, about 0.5 wt % to about 15 wt % fibrillated thermoplastic fibers; about 0 wt % to about 30 wt % fibrillated cellulose fibers; and about 0.5 parts to about 1.5 parts of cationic polymer; and
(iii) a second outer non-woven mat comprising or consisting of fibrillated cellulose fibers, optionally consisting of 100 wt % fibrillated cellulose fibers.

15. The multilayer filter media of claim 13 or claim 14, wherein the multilayer filter media has a minimum efficiency reporting value (MERV) rating of at least 12.

16. The multilayer filter media of claim 15, wherein the multilayer filter media has a MERV rating of at least 13.

17. A method of filtering a stream of flowing air, the method comprising passing the stream of flowing air through a biodegradable filter media of any one of claims 1-11.

18. A method of preparing a biodegradable filter media, the method comprising:
(i) providing a fiber mixture, wherein the fiber mixture comprises cellulose fibers and fibrillated thermoplastic fibers;
(ii) forming a nonwoven mat from the fiber mixture; and
(iii) drying the nonwoven mat, thereby providing the biodegradable filter media.

19. The method of claim 18, wherein step (iii) comprises removing excess water under vacuum and drying the nonwoven mat in an oven.

20. The method of claim 18 or claim 19, further comprises preparing an electret from the nonwoven fiber by passing the nonwoven mat through an electric field; injecting charge carriers; and/or by corona discharge.

21. A biodegradable filter media comprising cellulose fibers, fibrillated thermoplastic fibers, and starch nanoparticles.
